(19) United States
(12) Patent Application Publication
(10) Pub. No.: US 2026/0348557 A1
(43) Pub. Date: Nov. 5, 2026

(54) Laser-phosphor based fixture with polarization dependent beam shaping

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 18/997,346

(22) PCT Filed: Jul. 14, 2023
(86) PCT No.: PCT/EP2023/069604

§ 371 Date: Jan. 21, 2025

(30) Foreign Application Priority Data
Jul. 26, 2022 (EP) 22186870.6

(51) Int. Cl. F21V 9/38; F21S 10/02; F21V 9/32; F21V 29/71; F21Y 115/30; G02B 27/28; G02B 27/30

(52) U.S. Cl. CPC F21V 9/38; F21S 10/023; F21V 9/32; F21V 29/71; G02B 27/283; G02B 27/30; F21Y 2115/30

(57) ABSTRACT

The invention provides a light generating system (1000) comprising one or more light generating devices (100), a first luminescent body (210), a second luminescent body (220), an optics arrangement (400), a collimator (500), a heat transfer system (700), and a control system (300) wherein: the one or more light generating devices (100) may be configured to generate device light (101) having a first wavelength (λ1) and having a controllable polarization, wherein the one or more light generating devices (100) comprise one or more solid state light sources; wherein collimator (500) may have a first end (501) and a second end (502), wherein the collimator (500) may taper from the second end (502) to the first end (501); wherein the first luminescent body (210) may be configured to convert at least part of light having the first wavelength (λ1) into first luminescent material light (211); wherein the second luminescent body (220) and may be configured to convert at least part of light having the first wavelength (λ1) into second luminescent material light (221); wherein the first luminescent body (210) and the second luminescent body (220) may be configured in the collimator (500), wherein the first luminescent body (210) may be configured closer to the first end (501) than the second luminescent body (220) and the second luminescent body (220) may be configured closer to the second end (502) than the first luminescent body (210), and wherein the heat transfer system (700) is configured to transfer heat from one or more of the first luminescent body (210) and the second luminescent body (220); wherein the optics arrangement (400) may be configured to direct the device light (101) to the first luminescent body (210) and/or the second luminescent body (220) in dependence of the polarization of the device light (101); wherein the light generating system (1000) may be configured to generate system light (1001) comprising one or more of the first luminescent material light (211) and the second luminescent material light (221); and wherein the control system (300) may be configured to control the polarization of the device light (101).

### FIELD OF THE INVENTION

The invention relates to a light generating system. The invention further relates to a lighting device (comprising such light generating system).

### BACKGROUND OF THE INVENTION

Laser light sources are known in the art. For instance, US2021156526A1, describes a light source device including a laser light source for emitting a first light, a refractive optical element disposed on a light exiting path of the laser light source and configured to guide the first light to a light conversion device. The refractive optical element includes a light-exiting surface and light reflected by the light-exiting surface of the refractive optical element is deflected towards the light conversion device to exit. The light conversion device is disposed at a light-exiting side of the refractive optical element and the incident surface and light-exiting surface thereof are the same surface. The medium of the incident surface of the light conversion device has Brewster' angle of a and outgoing light of the refractive optical element is obliquely incident to the light conversion device at an incident angle of α−20° to α+10°. Also, the light collecting device is disposed at the light-exiting side of the light conversion device and configured to collect light emitted from the light conversion device and then emit it.

### SUMMARY OF THE INVENTION

High brightness light sources can be used in various applications including spots, stage-lighting, headlamps, home and office lighting, and automotive lighting. For this purpose, laser-phosphor technology can be used, wherein a laser provides laser light and a remote phosphor converts laser light into converted light.

A relatively easy way to produce white light using lasers is to use blue laser light in combination with phosphor converted light to produce white light. However, current laser lighting fixtures may be unable to produce a reliable and high performance strong beam of light. Especially, current laser lighting fixtures may be unable to produce a beam of laser light with a controllable beam shape in a reliable and simple manner. Other problems associated with such laser light sources may come with the desire to create compact high power devices.

Hence, it is an aspect of the invention to provide an alternative (laser-based) light generating system, which preferably further at least partly obviates one or more of above-described drawbacks. The present invention may have as object to overcome or ameliorate at least one of the disadvantages of the prior art, or to provide a useful alternative.

According to a(n) (first) aspect, the invention provides a light generating system (“system”) comprising one or more light generating devices (or “radiation generating devices”), a first luminescent body, a second luminescent body, an optics arrangement, a collimator, and a control system. The one or more light generating devices may especially be configured to generate device light having a first wavelength. Further, the one or more light generating devices comprise one or more solid state light sources. More especially, the one or more solid state light sources may comprise laser light sources. Especially, the collimator has a first end and a second end. Further, especially the collimator may taper from the second end to the first end. In embodiments, the first luminescent body may be configured to convert at least part of light having the first wavelength (λ1) into first luminescent material light. Yet, in embodiments the second luminescent body may be configured to convert at least part of light having the first wavelength (λ1) into second luminescent material light. Especially, the first luminescent body and the second luminescent body may be configured in the collimator. In embodiments, the first luminescent body may be configured closer to the first end than the second luminescent body. Further, the system may optionally comprise a heat transfer system. For instance, the heat transfer system may be configured to transfer heat from one or more of the first luminescent body and the second luminescent body. More especially, in embodiments the first luminescent body and/or the second luminescent body may be configured in thermal contact with one or more heat sinks. In embodiments, the optics arrangement may be configured to direct the device light to the first luminescent body and/or the second luminescent body. Further, especially the light generating system may be configured to generate system light comprising one or more of the first luminescent material light and the second luminescent material light. In embodiments, the beam shape of the system light may be controllable. In further specific embodiments, the control system may be configured to control the system light, especially by controlling the one or more light generating devices. Hence, the invention provides in embodiments a light generating system comprising one or more light generating devices, a first luminescent body, a second luminescent body, an optics arrangement, a collimator, a control system, and optionally a heat transfer system; wherein: (A) the one or more light generating devices are configured to generate device light having a first wavelength (λ1); wherein the one or more light generating devices comprise one or more solid state light sources, wherein the one or more solid state light sources comprise laser light sources; (B) the collimator has a first end and a second end, wherein the collimator tapers from the second end to the first end; (C) the first luminescent body is configured to convert at least part of light having the first wavelength (λ1) into first luminescent material light; (D) the second luminescent body is configured to convert at least part of light having the first wavelength (λ1) into second luminescent material light; (E) the first luminescent body and the second luminescent body are configured in the collimator, wherein the first luminescent body is configured closer to the first end than the second luminescent body; (F) the heat transfer system is configured to transfer heat from one or more of the first luminescent body and the second luminescent body; (G) the optics arrangement is configured to direct the device light to the first luminescent body and/or the second luminescent body; (H) the light generating system is configured to generate system light comprising one or more of the first luminescent material light and the second luminescent material light; especially wherein the system light has a controllable beam shape; and (I) the control system is configured to control the system light by controlling the one or more light generating devices (100). In specific embodiments, the control system may (thereby) control the beam shape of the system light. According to an (other) aspect, the invention provides a light generating system (“system”) comprising one or more light generating devices (or “radiation generating devices”), a first luminescent body, a second luminescent body, an optics arrangement, a collimator, and a control system. The one or more light generating devices may especially be configured to generate device light having a first wavelength λ1. More especially, the one or more light generating devices may have a controllable polarization. Further, in embodiments, the one or more light generating devices may comprise one or more solid state light sources. The collimator especially may have a first end and a second end. More especially, the collimator may taper from the second end to the first end. In embodiments, the first luminescent body may be configured to convert at least part of light having the first wavelength λ1 into first luminescent material light. Further, in embodiments, the second luminescent body may be configured to convert at least part of light having the first wavelength λ1 into second luminescent material light. The first luminescent body and the second luminescent body may especially be configured in the collimator. More especially, the first luminescent body may be configured closer to the first end than the second luminescent body. Hence, the second luminescent body may be configured closer to the second end than the first luminescent body. Further, in embodiments, the system may further comprise a heat transfer system configured to transfer heat from one or more of the first luminescent body and the second luminescent body. In specific embodiments, the heat transfer system may comprise one or more heat sinks. Yet, in further embodiments the first luminescent body and the second luminescent body may be configured in thermal contact with the one or more heat sinks. The optics arrangement may be configured to direct the device light to the first luminescent body and/or the second luminescent body in dependence of the polarization of the device light. Further, the light generating system may be configured to generate system light comprising one or more of the first luminescent material light and the second luminescent material light. Yet further, in embodiments, the control system may be configured to control the polarization of the device light. Especially, the control system may be configured to control a beam shape of the system light. Hence, the system light may in embodiments have a controllable beam shape. In specific embodiments, the invention provides a light generating system comprising one or more light generating devices, a first luminescent body, a second luminescent body, an optics arrangement, a collimator, optionally a heat transfer system, and a control system: wherein the one or more light generating devices may be configured to generate device light having a first wavelength λ1 and having a controllable polarization; wherein the one or more light generating devices may comprise one or more solid state light sources; wherein the collimator may have a first end and a second end, wherein the collimator may taper from the second end to the first end; wherein the first luminescent body may be configured to convert at least part of light having the first wavelength λ1 into first luminescent material light; wherein the second luminescent body and may be configured to convert at least part of light having the first wavelength λ1 into second luminescent material light; wherein the first luminescent body and the second luminescent body may be configured in the collimator, wherein the first luminescent body may be configured closer to the first end than the second luminescent body and the second luminescent body may be configured closer to the second end than the first luminescent body; wherein the heat transfer system configured to transfer heat from one or more of the first luminescent body and the second luminescent body (in embodiments, the first luminescent body and/or the second luminescent body may be configured in thermal contact with one or more heat sinks); wherein the optics arrangement may be configured to direct the device light to the first luminescent body and/or the second luminescent body in dependence of the polarization of the device light; wherein the light generating system may be configured to generate system light comprising one or more of the first luminescent material light and the second luminescent material light; wherein in specific embodiments the system light has a controllable beam shape, and wherein the control system may be configured to control the polarization of the device light (and may (thereby) (also) control in embodiments the beam shape of the system light. In embodiments, the control system may be configured to control the system light, such as its beam shape, by controlling the one or more light generating devices.

With the present system, it may be possible to improve the functionality and performance of laser-phosphor based lighting in a reliable and simple way. It may especially be possible to provide a relatively cheap, reliable, and simple laser-based light generating system, e.g. for stage-lighting purposes. Additionally, the present system may provide dynamic beam shaping of (laser-based) light beams. Therefore, amongst others, the invention provides a laser-phosphor based fixture with polarization dependent beam shaping. The invention allows control of beam shape, without the necessary need of moving elements.

As indicated above, in embodiments, the light generating system may comprise one or more light generating devices, a first luminescent body, a second luminescent body, an optics arrangement, a collimator, and a control system. Here below, first some general embodiments of the system are described, followed by some more specific embodiments.

In embodiments, the light generating system may comprise one or more (types of) light generating devices, such as a plurality of first light generating devices and/or second light generating devices. The one or more light generating devices may especially be configured to generate device light.

The device light may especially have a first wavelength λ1. In embodiments, the first wavelength λ1 may be selected from the range of 380-780 nm, such as from the range of 380-520 nm. Hence, in embodiments, the device light may be visible light, especially colored light. In specific embodiments, the device light may comprise blue light, i.e. light with a first wavelength λ1 selected from the range of 440-490 nm. Further embodiments of the light generating device(s) are described below.

In more specific embodiments, the one or more light generating devices may be configured to generate blue (polarized) laser radiation. For instance, in combination with a yellow emitting phosphor, this may provide white light (in an operational mode). Yet in further embodiments, the device light may have a first wavelength λ1 outside of the visible wavelength range, i.e. the first wavelength λ1 may be in the UV or IR wavelength range. Especially, however, λ1 may be in the visible wavelength range, more especially in the blue wavelength range.

With the optics arrangement and the device light, it can be chosen which of the first luminescent body and the second luminescent body is addressed with the device light. Several options are proposed below, of which some of them are based on polarized light and others do not necessarily include polarized light.

The one or more light generating devices may especially be configured to generate device light with a controllable polarization, i.e. a polarization state of the device light may be controllable. The polarization state of the device light may, in embodiments, comprise s-polarized radiation and/or p-polarized radiation. In a particular embodiment, the polarization state of the device light may comprise a combination of s-polarized and p-polarized radiation. Especially, the polarization state is controllable, i.e. it can be chosen whether the device light has a p-polarization or has an s-polarization.

In embodiments, radiation at a specific wavelength may be s-polarized when at that wavelength 90% of the radiation has s-polarization, like at least 95%, such as essentially 100%. Likewise, in embodiments, radiation at a specific wavelength may be p-polarized when at that wavelength 90% of the radiation has p-polarization, like at least 95%, such as essentially 100%. Hence, s-polarized radiation may in embodiments essentially have 100% s-polarization and p-polarized radiation may in embodiments essentially have 100% p-polarization.

Hence, in embodiments the device light may during a first operational mode of the light generating system be at least 95% s-polarized, and during a second operational mode of the light generating system be at least 95% p-polarized.

In other embodiments, the polarization state of the device light may comprise right handed circular polarization (RHC) and/or left handed circular polarization (LHC).

In other embodiments, the polarization state of the device light may comprise p-polarized light and s-polarized light.

It is also possible to provide unpolarized light a polarization. This will further also be described below.

Especially, the one or more light generating devices may comprise one or more light sources, such as one or more LED light sources, one or more laser diodes, and/or one or more superluminescent diode light sources, see also further below. Especially, the one or more light generating devices may comprise one or more solid state light sources, such as one or more laser diodes.

The system further comprises a collimator. The collimator may be used to beam shape the light generated by the first luminescent body and/or the second luminescent body, and optionally remaining device light. This will be further described below.

The collimator may have a first end and a second end. Especially, the collimator may taper from the second end to the first end. The collimator may further, in embodiments, have a collimator axis O_{c} centered within the collimator (see also further below). The first end and the second end of the collimator may be arranged such that the collimator axis O_{c} may form an imaginary connection between the first end and the second end. Especially, the second end may be arranged downstream of both the first luminescent body and the second luminescent body. More especially, in embodiments, the second end may be an opening (hollow reflector) or a plane (TIR collimator). Further, essentially luminescent material light from the first luminescent body and/or from the second luminescent body, as well as optional device light, may essentially only escape from the collimator via the second end. The first end may especially be arranged upstream of both the first luminescent body and the second luminescent body. In particular embodiments, the first end may comprise a cavity (see also further below).

Further, the collimator may, in embodiments, have a cross-sectional shape selected from the group comprising an n-gonal prism shape with n being at least 4 (such as square, hexagonal), or a cylindrical (circular cross-sectional shape). Other shapes, however, may also be possible.

Especially, the collimator may have a cross-sectional area Aₒ defined perpendicular to the collimator axis O_{c}. The collimator cross-sectional area Aₒ may especially vary over a length of the collimator axis O_{c}. The collimator cross-sectional area Aₒ may, in embodiments, be selected from the range of 10-5000 mm², such as from the range of 50-1000 mm², like from the range of 100-500 mm². Especially, the collimator cross-sectional area Aₒ may be at least 5 mm², such as at least 10 mm², like at least 50 mm². Further, the collimator cross-sectional area Aₒ may be at most 5000 mm², such as at most 1000 mm², like at most 500 mm². The cross-sectional area may be maximum at the second end, and smallest, or even zero, at the first end.

The first luminescent body may, in embodiments, be a phosphor tile, a phosphor disc, or a phosphor plate. In embodiments, the first luminescent may be a (relatively small) tile.

Further, in embodiments, the first luminescent body may be configured to partially convert the device light. The first luminescent body may therefore also be configured in a reflective or in a transmissive mode (see also below). In other embodiments, the first luminescent body may be configured to essentially fully convert the device light. The first luminescent body comprises a first luminescent material. Hence, the first luminescent body may be configured to convert at least part of light having the first wavelength λ1 into first luminescent material light. The first luminescent body may especially be configured to convert under perpendicular radiation at least 60% of light having the first wavelength λ1 into first luminescent material light, such as at least 70%, like at least 80%, especially at least 90%, more especially at least 95%, like at least 99%, including 100%.

The second luminescent body may, in embodiments, be a phosphor tile, a phosphor disc, or a phosphor plate. In embodiments, the second luminescent may be a (relatively small) tile.

Further, in embodiments, the second luminescent body may be configured to partially convert the device light. The second luminescent body may therefore also be configured in a reflective or in a transmissive mode (see also below). In other embodiments, the second luminescent body may be configured to essentially fully convert the device light. The second luminescent body comprises a second luminescent material. Hence, the second luminescent body may be configured to convert at least part of light having the first wavelength λ1 into second luminescent material light. The second luminescent body may especially be configured to convert under perpendicular radiation at least 60% of light having the first wavelength λ1 into second luminescent material light, such as at least 70%, like at least 80%, especially at least 90%, more especially at least 95%, like at least 99%, including 100%.

Yet further, in embodiments, the light generating system may comprise a heat transfer system. Especially, the heat transfer system may be configured to transfer heat from one or more of the first luminescent body and the second luminescent body. For instance, the heat transfer system may comprise one or more heat sinks (see also below). Hence, in specific embodiments the first luminescent body and the second luminescent body may be configured in thermal contact with one or more heat sinks. For example, in embodiments, the first and second luminescent body may be configured in thermal contact with the same one or more heat sinks, such as the same one heat sink. In other embodiments, the first and second luminescent body may be configured in thermal contact with two or more separate heat sinks.

A luminescent body may be configured in a reflective mode such that the luminescent body essentially fully reflects light that is unconverted by the luminescent body. Further, a luminescent body may be configured in a transmissive mode such that the luminescent body essentially fully transmits light that is unconverted by the luminescent body. Hence, the first and/or second luminescent body may be transparent or light scattering.

Hence, the luminescent material may be configured in the reflective mode or in the transmissive mode. In the transmissive mode, it may be relatively easy to have light source light admixed in the luminescent material light, which may be useful for generating the desirable spectral power distribution. In the reflective mode, thermal management may be easier, as a substantial part of the luminescent material may be in thermal contact with a thermally conductive element, like a heatsink or heat spreader. In the reflective mode, a part of the light source light may in embodiments be reflected by the luminescent material and/or a reflector and may be admixed in the luminescent material light. The reflector may be configured downstream of the luminescent material (in the reflective mode).

Especially, the luminescent material may be comprised by a luminescent body. The luminescent body may be a layer, like a self-supporting layer. The luminescent body may also be a coating. The luminescent body may also comprise a luminescent coating on a support (especially a light transmissive support in the transmissive mode, or a reflective support in the reflective mode). Especially, the luminescent body may essentially be self-supporting. In embodiments, the luminescent material may be provided as luminescent body, such as a luminescent single crystal, a luminescent glass, or a luminescent ceramic body. Such body may be indicated as “converter body” or “luminescent body”. In embodiments, the luminescent body may be a luminescent single crystal or a luminescent ceramic body. For instance, in embodiments a cerium comprising garnet luminescent material may be provided as a luminescent single crystal or as a luminescent ceramic body. In other embodiments, the luminescent body may comprise a light transmissive body, wherein the luminescent material is embedded. For instance, the luminescent body may comprise a glass body, with luminescent material embedded therein. Or, the glass as such may be luminescent. In other embodiments, the luminescent body may comprise a polymeric body, with luminescent material embedded therein.

Especially, the first and the second luminescent body may be configured in a light receiving relationship with the one or more light generating devices. However, the first luminescent body is not necessarily configured in a light receiving relationship with the same light generating device(s) as the second luminescent body. In embodiments, this may be the case, whereas in other embodiments that may not be the case.

The terms “light-receiving relationship” or “light receiving relationship”, and similar terms, may indicate that an item may during operation of a source of light (like a light generating device or light generating element or light generating system) may receive light from that source of light. Hence, the item may be configured downstream of that source of light. Between the source of light and the item, optics may be configured.

The terms “upstream” and “downstream” relate to an arrangement of items or features relative to the propagation of the light from a light generating means (here especially the light generating device), wherein relative to a first position within a beam of light from the light generating means, a second position in the beam of light closer to the light generating means is “upstream”, and a third position within the beam of light further away from the light generating means is “downstream”.

The terms “radiationally coupled” or “optically coupled” or “radiatively coupled” may especially mean that (i) a light generating element, such as a light source, and (ii) another item or material, are associated with each other so that at least part of the radiation emitted by the light generating element is received by the item or material. In other words, the item or material is configured in a light-receiving relationship with the light generating element. At least part of the radiation of the light generating element will be received by the item or material. This may in embodiments be directly, such as the item or material in physical contact with the (light emitting surface of the) light generating element. This may in embodiments be via a medium, like air, a gas, or a liquid or solid light guiding material. In embodiments, also one or more optics, like a lens, a reflector, an optical filter, may be configured in the optical path between light generating element and item or material. The term “in a light-receiving relationship” does, as indicated above, not exclude the presence of intermediate optical elements, such as lenses, collimators, reflectors, dichroic mirrors, etc. In embodiments, the term “light-receiving relationship” and “downstream” may essentially be synonyms.

Especially, the luminescent material may be configured to convert at least part of device light into luminescent material light. More especially, the luminescent material light may comprise visible light, such as having a color point in the yellow or green or red, etc., especially in the visible.

The first luminescent body and second luminescent body may be configured in the collimator. Especially, the first luminescent body may be configured closer to the first end than the second luminescent body, and hence, the second luminescent body may be configured closer to the second end than the first luminescent body. Hence, in embodiments the collimator may be hollow or may comprise a cavity.

In embodiments, the collimator may have a focal point. Especially, in embodiments, the focal point may be closer to the first end of the collimator than the second end. The collimator may further have a collimator height h parallel to the collimator axis O_{c}. Especially, the height may be defined starting from the first end. The first luminescent body may be configured in the collimator closer to the first end. The second luminescent body may be configured in the collimator closer to the second end. Especially, in embodiments, the first luminescent body may be arranged in between 0-x % of the collimator height h, wherein x may be at most 35%, such as at most 25%. Further, in embodiments, the second luminescent body may be arranged in between y-100% of the collimator height h, wherein y may be at least 40%, such as at least 50%. Furthermore, in embodiments, x and y may differ at least 10 percentage point, such as at least 25 percentage point, especially at least 40 percentage point.

Hence, in embodiments, the first luminescent body may have a first distance d1 to the focal point. Likewise, the second luminescent body may have a second distance d2 to the focal point. In embodiments, the first distance d1 and the second distance d2 may be individually selected from the range of 2-200 mm, such as from the range of 5-100 mm, like from the range of 10-50 mm, though especially d1<d2. Especially, in embodiments, the first distance d1 may be at most 150 mm, like at most 100 mm, especially at most 50 mm. Further, the first distance d1 may, in embodiments, be selected from the range of 0-20 mm, such as 0-10 mm. In specific embodiments, the first distance d1 may be zero, i.e. the first luminescent body may be configured on the focal point. Likewise, in embodiments, the second distance d2 may be at most 200 mm, such as at most 150 mm, like at most 100 mm, especially at most 50 mm. Further, the second distance d2 may, in embodiments, be at least 2 mm, such as at least 5 mm, like at least 10 mm, especially at least 15 mm. Especially, in embodiments, these distances may be selected such that the first distance d1 may be substantially smaller than the second distance d2, i.e. d1/d2≤0.25 such as d1/d2≤0.1, like d1/d2≤0.05. In embodiments, d1=0 mm, and d2 is at least 2 mm.

The first and/or second luminescent body may have a cross-sectional area relative to the collimator cross-sectional area Aₒ (see also above). Especially, the cross-sectional area of the first and/or second luminescent body may be smaller than the (respective) collimator cross-sectional area Aₒ. Especially, the first luminescent body may have a first cross-sectional area A₁₁ defined perpendicular to the collimator axis Oc. More especially, the first cross-sectional area A₁₁ may be selected from the range of 1-100 mm², such as from the range of 2-50 mm², like from the range of 5-20 mm². The first cross-sectional area A₁₁ may be at least 0.5 mm², such as at least 1 mm², like at least 2 mm². Further, the first cross-sectional area A₁₁ may be at most 100 mm², such as at most 50 mm², like at most 25 mm². Yet further, the first cross-sectional area A₁₁ may be selected such that A₁₁/Aₒ≤0.2, like such that A₁₁/Aₒ≤0.1, especially such that A₁₁/Aₒ≤0.05.

Likewise, in embodiments, the second luminescent body may have a second cross-sectional area A₁₂ defined perpendicular to the collimator axis Oc. Especially, the second cross-sectional area A₁₂ may be selected from the range of 1-100 mm², such as from the range of 2-50 mm², like from the range of 5-20 mm². The second cross-sectional area A₁₂ may be at least 0.5 mm², such as at least 1 mm², like at least 2 mm². Further, the second cross-sectional area A₁₂ may be at most 100 mm², such as at most 50 mm², like at most 25 mm². Yet further, the second cross-sectional area A₁₂ may be selected such that A₁₂/Aₒ≤0.2, like such that A₁₂/Aₒ≤0.1, especially such that A₁₂/Aₒ≤0.05.

In embodiments 0.25≤A₁₂/A₁₁≤2. Hence, in embodiments, the first cross-sectional area and the second cross-sectional area may be equal in size. However, in other embodiments, the first cross-sectional area and the second cross-sectional area may be slightly different in size. Especially, in embodiments 0.5≤A₁₂/A₁₁≤1.5, such as A₁₂/A₁₁=1.

In embodiments, the first and/or second luminescent body (or “body”) may have lateral dimensions width or length (W or L) or diameter (D) and a thickness or height (H). In embodiments, (i) D≥H or (ii) and W≥H and/or L≥H. In specific embodiments, L≤10 mm, such as especially L≤5 mm, more especially L≤3 mm, most especially L≤2 mm. In specific embodiments, W≤10 mm, such as especially W≤5 mm, more especially W≤3 mm, most especially W≤2 mm. In specific embodiments, H≤10 mm, such as especially H≤5 mm, more especially H≤3 mm, most especially H≤2 mm. In specific embodiments, D≤10 mm, such as especially D≤5 mm, more especially D≤3 mm, most especially D≤2 mm. In specific embodiments, the body may have in embodiments a thickness in the range 50 μm-1 mm. Further, the body may have lateral dimensions (width/diameter) in the range 100 μm-10 mm. In yet further specific embodiments, (i) D>H or (ii) W1>H and L1>H. Especially, the lateral dimensions like length, width, and diameter are at least 2 times, like at least 5 times, larger than the height.

The first and/or second luminescent body may have any shape. In general, however, the first and/or second luminescent body may comprise two essentially parallel faces, defining a height (of the luminescent body). Further, the first and/or second luminescent body may comprise an edge face, bridging the two essentially parallel faces. The edge face may be curved in one or two dimensions. The edge face may be planar. The first and/or second luminescent body may have a rectangular or circular cross-section, though other cross-sections may also be possible, like e.g. hexagonal, octagonal, etc. Hence, the first and/or second luminescent body may have a circular cross-section, an oval cross-section, square, or non-square rectangular. In embodiments, the first and/or second luminescent body may have an n-gonal cross-section, wherein n is at least 3, like 4 (square or rectangular cross-section), 5 (pentagonal cross-section), 6 (hexagonal cross-section), 8 (octagonal cross-section) or higher. The two essentially parallel faces may also be indicated as “main faces”, as they may especially provide the largest external area of the first and/or second luminescent body. Perpendicular to the afore-mentioned cross-section, may be another cross-section, which may in embodiments be rectangular. Hence, the first and/or second luminescent body may e.g. have a cubic shape, a (non-cubic) cuboid shape, an n-gonal prism shape with n being at least 5 (such as pentagonal prism, hexagonal prism), and a cylindrical shape. Other shapes, however, may also be possible. Especially, the first and/or second luminescent body may have a cuboid shape, a cylindrical shape, or an n-gonal prism shape wherein n is 6 or 8. In the case of a cylindrical shape, the edge face may be a single edge face. In the case of a cuboid, the edge face may comprise four facets. In the case of a hexagonal prism the edge face may comprise six facets.

In particular embodiments, the cross-sectional shape of the first and/or second luminescent body may be selected dependent on the collimator cross-sectional shape. For example, in embodiments, the collimator may have a hexagonal or circular cross-sectional shape. In such an embodiment, the second luminescent body may also have a hexagonal or circular cross-sectional shape and the first luminescent body may have such cross-sectional shape as well. However, in (other) embodiments, the cross-sectional shape of the first and/or second luminescent body may also be selected independent on the collimator cross-sectional shape.

In embodiments, the first luminescent body and the second luminescent body may have the same cross-sectional shape, i.e. the first luminescent body and the second luminescent body may have equal dimensions. In other embodiments, the first luminescent body and the second luminescent body may have a different cross-sectional shape, i.e. the first luminescent body and the second luminescent body may have unequal dimensions. For example, in particular embodiments, the second luminescent body may be relatively larger than the first luminescent body.

The optics arrangement may comprise a variety of optical components, such as one or more of a retarder, a beam splitter, a shutter, a reflector and a lens (see also further below). The optics arrangement may especially be configured to direct the device light to the first luminescent body or the second luminescent body.

In particular embodiments, the optics arrangement may be configured to direct the device light to the first and the second luminescent body in dependence of the polarization of the device light. For example the optics arrangement may, in embodiments, be configured to direct device light with p-polarization to the second luminescent body. In another example the optics arrangement may, in embodiments, be configured to direct device light with s-polarization to the first luminescent body. However, in embodiments, the optics arrangement may also be configured to direct device light to the first and/or second luminescent body independent of the polarization of the device light. Such embodiments of the optics arrangement will be discussed in more detail further below.

Further, the light generating system may be configured to generate system light. The system light may comprise at least one or more of unconverted device light, first luminescent material light, and second luminescent material light, especially at least one or more of the first luminescent material light and the second luminescent material light.

In an operational mode, the system light may comprise unconverted device light. However, in another operational mode, the system light may at least partially (or even fully) comprise first luminescent material light, i.e. the first luminescent body may be configured to at least partially convert the device light into first luminescent material light. In yet other embodiments, the system light may at least partially (or even fully) comprise second luminescent material light, i.e. the second luminescent body may be configured to at least partially convert the device light into second luminescent material light. In yet other embodiments, the system light may at least partially (or even fully) comprise first and second luminescent material light, i.e. the first and second luminescent body may be configured to at least partially convert device light into (respectively) first and second luminescent material light.

The collimator axis O_{c} (see also above) may be defined as an imaginary line that defines a path through the collimator along which system light propagates out of the system. Especially, the collimator axis may coincide with the direction of system light with the highest radiant flux.

As will be elucidated further below, with the one or more light generating devices and the optical system, the different luminescent bodies may be addressed. In embodiments, the polarization of the device light may be controllable, by which, together with the optical system, the device light may be directed to the respective luminescent bodies in dependence of the polarization (of the device light of the one or more light generating devices). This can be obtained with one or more light generating devices. Alternatively or additionally, by using two or more light generating devices which are configured to generate device light, which is not necessarily polarized light, in combination with the optical system, the device light may be directed to the respective luminescent bodies (in dependence of the two or more light generating devices).

In embodiments, device light may be directed to the respective luminescent bodies in dependence of e.g. a beam splitter and a shutter, comprised by the optics arrangement. Especially the device light may be directed to the respective luminescent bodies independently of the polarization of the device light. In particular, the device light may even be unpolarized device light. Thus, such embodiments may require the use of one or more (dynamic) optics elements such as selected from the group of a beam splitter, a shutter, a partial reflector, or an electronically controlled mirror. Such (dynamic) optics elements may be controlled by the control system.

Hence, the control system may be configured to control the device light. Especially, the control system may be configured to control one or more of a polarization of the device light, and a radiant flux of the device light. In embodiments, the control system may be configured to control the polarization of the device light (see further below).

Alternatively or additionally, the control system may be configured to control the radiant flux of the one or more light generating devices. This may include the control of an on mode and off mode, and optionally intermediate radiant fluxes.

The control system may also be configured to control the system light. Especially, the control system may be configured to control one or more of the polarization of the system light, a beam shape of the system light and a radiant flux of the system light. Especially, the control system may be configured to control the beam shape of the system light. In additional embodiments, the control system may be configured to control the color of the device light.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, which can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

In embodiments, the collimator may comprise a hollow first reflector. Especially, in embodiments, the hollow first reflector may provide specular reflection. In other embodiments, the collimator may comprise a TIR reflector.

As indicated above the collimator may comprise a hollow first reflector. In such an instance, the collimator may be open at the second end. However, in embodiments, the collimator may also comprise a light transmissive material (then the second end may be a (planar) face of the light transmissive material). The light transmissive material is especially transparent.

In embodiments, the hollow first reflector may comprise a metallic coating, especially a coating having a high specular reflectivity. For instance, the metallic coating may be an aluminum coating or a silver coating. In a specific embodiment, such metal coating may be covered with a transparent material to protect the metal from aging. Alternatively, in embodiments, the hollow first reflector may comprise an interference coating having a high specular reflectivity. Especially, the interference coating may consist of a stack of transparent layers having alternated refractive indices. In this way, a reflective surface may be obtained.

As indicated above, in yet other embodiments, the collimator may comprise a light transparent material. Especially, in such embodiments the collimator may be based on total internal reflection (TIR) reflector. Such TIR reflector may especially be configured such that the light rays originating from the light source cannot leave the side wall(s) of the transparent body due to total internal reflections. Also such TIR reflector may comprise a light reflective coating (on the side wall(s), especially a specular light reflective coating, such as in embodiments a metallic coating Furthermore, as is known in the art, a TIR reflector may comprise a(n optical) cavity (at the first end). Additionally or alternatively, in embodiments wherein the collimator may comprise a TIR reflector, the collimator may also comprise a third reflector. The third reflector may especially be configured in the (optical) cavity. More especially, in embodiments, the third reflector may be attached to the first end of the collimator.

As discussed above, the light generating system may comprise one or more light generating devices. In embodiments, the one or more light generating devices may comprise one or more lasers, especially diode lasers. Additionally or alternatively, in embodiments, the one or more light generating devices may comprise one or more superluminescent diodes. Also, in embodiments, the one or more light generating device may comprise one or more lasers and one or more superluminescent diodes.

The one or more light generating devices may be configured to generate device light. Especially, in embodiments, the one or more light generating devices may be configured to generate polarized radiation. To this end, the one or more light generating devices may comprise a light source, such as a laser light source, configured to generate light source light. Hence, in embodiments, the one or more light generating devices may comprise one or more lasers. In other embodiments, the one or more light generating devices may comprise one or more superluminescent diodes. In yet other embodiments, the one or more light generating devices may comprise one or more lasers and one or more superluminescent diodes.

The term “light source” may also relate to a plurality of (essentially identical (or different)) light sources, such as 2-200 (solid state) LED light sources. Hence, the term LED may also refer to a plurality of LEDs.

The light source has a light escape surface. Referring to conventional light sources such as light bulbs or fluorescent lamps, it may be outer surface of the glass or quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes form the light exit surface of the light source.

The term “light source” may refer to a semiconductor light-emitting device, such as a light emitting diode (LEDs), a resonant cavity light emitting diode (RCLED), a vertical cavity laser diode (VCSELs), an edge emitting laser, etc . . . The term “light source” may also refer to an organic light-emitting diode, such as a passive-matrix (PMOLED) or an active-matrix (AMOLED). In a specific embodiment, the light source comprises a solid-state light source (such as a LED or laser diode). In an embodiment, the light source comprises a LED (light emitting diode). The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. In embodiments, a COB is a multi LED chip configured together as a single lighting module.

In embodiments, the light source may comprise one or more micro-optical elements (array of micro lenses) downstream of a single solid-state light source, such as a LED, or downstream of a plurality of solid-state light sources (i.e. e.g. shared by multiple LEDs). In embodiments, the light source may comprise a LED with on-chip optics. In embodiments, the light source comprises a pixelated single LEDs (with or without optics) (offering in embodiments on-chip beam steering).

The term “laser light source” especially refers to a laser. Such laser may especially be configured to generate laser light source light having one or more wavelengths in the UV, visible, or infrared, especially having a wavelength selected from the spectral wavelength range of 200-2000 nm, such as 300-1500 nm. The term “laser” especially refers to a device that emits light through a process of optical amplification based on the stimulated emission of electromagnetic radiation.

Especially, in embodiments the term “laser” may refer to a solid-state laser. In specific embodiments, the terms “laser” or “laser light source”, or similar terms, refer to a laser diode (or diode laser).

Hence, in embodiments the light source comprises a laser light source. In embodiments, the terms “laser” or “solid state laser” may refer to one or more of cerium doped lithium strontium (or calcium) aluminum fluoride (Ce:LiSAF, Ce:LiCAF), chromium doped chrysoberyl (alexandrite) laser, chromium ZnSe (Cr:ZnSe) laser, divalent samarium doped calcium fluoride (Sm:CaF₂) laser, Er:YAG laser, erbium doped and erbium-ytterbium codoped glass lasers, F-Center laser, holmium YAG (Ho:YAG) laser, Nd:YAG laser, NdCrYAG laser, neodymium doped yttrium calcium oxoborate Nd:YCa₄O(BO₃)₃ or Nd:YCOB, neodymium doped yttrium orthovanadate (Nd:YVO₄) laser, neodymium glass (Nd:glass) laser, neodymium YLF (Nd:YLF) solid-state laser, promethium 147 doped phosphate glass (147Pm³⁺:glass) solid-state laser, ruby laser (Al₂O₃:Cr³⁺), thulium YAG (Tm:YAG) laser, titanium sapphire (Ti:sapphire; Al₂O₃:Ti³⁺) laser, trivalent uranium doped calcium fluoride (U:CaF₂) solid-state laser, Ytterbium doped glass laser (rod, plate/chip, and fiber), Ytterbium YAG (Yb:YAG) laser, Yb₂O₃ (glass or ceramics) laser, etc.

In embodiments, the terms “laser” or “solid state laser” may refer to one or more of a semiconductor laser diode, such as GaN, InGaN, AlGaInP, AlGaAs, InGaAsP, lead salt, vertical cavity surface emitting laser (VCSEL), quantum cascade laser, hybrid silicon laser, etc.

A laser may be combined with an upconverter in order to arrive at shorter (laser) wavelengths. For instance, with some (trivalent) rare earth ions upconversion may be obtained or with non-linear crystals upconversion can be obtained. Alternatively, a laser can be combined with a downconverter, such as a dye laser, to arrive at longer (laser) wavelengths.

As can be derived from the below, the term “laser light source” may also refer to a plurality of (different or identical) laser light sources. In specific embodiments, the term “laser light source” may refer to a plurality N of (identical) laser light sources. In embodiments, N=2, or more. In specific embodiments, N may be at least 5, such as especially at least 8. In this way, a higher brightness may be obtained. In embodiments, laser light sources may be arranged in a laser bank (see also below). The laser bank may in embodiments comprise heat sinking and/or optics e.g. a lens to collimate the laser light.

The laser light source is configured to generate laser light source light (or “laser light”). The light source light may essentially consist of the laser light source light. The light source light may also comprise laser light source light of two or more (different or identical) laser light sources. For instance, the laser light source light of two or more (different or identical) laser light sources may be coupled into a light guide, to provide a single beam of light comprising the laser light source light of the two or more (different or identical) laser light sources. In specific embodiments, the light source light is thus especially collimated light source light. In yet further embodiments, the light source light is especially (collimated) laser light source light. The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The light source is especially configured to generate light source light having an optical axis (O), (a beam shape,) and a spectral power distribution. The light source light may in embodiments comprise one or more bands, having band widths as known for lasers. In specific embodiments, the band(s) may be relatively sharp line(s), such as having full width half maximum (FWHM) in the range of less than 20 nm at RT, such as equal to or less than 10 nm. Hence, the light source light has a spectral power distribution (intensity on an energy scale as function of the wavelength) which may comprise one or more (narrow) bands.

The beams (of light source light) may be focused or collimated beams of (laser) light source light. The term “focused” may especially refer to converging to a small spot. This small spot may be at the discrete converter region, or (slightly) upstream thereof or (slightly) downstream thereof. Especially, focusing and/or collimation may be such that the cross-sectional shape (perpendicular to the optical axis) of the beam at the discrete converter region (at the side face) is essentially not larger than the cross-section shape (perpendicular to the optical axis) of the discrete converter region (where the light source light irradiates the discrete converter region). Focusing may be executed with one or more optics, like (focusing) lenses. Especially, two lenses may be applied to focus the laser light source light. Collimation may be executed with one or more (other) optics, like collimation elements, such as lenses and/or parabolic mirrors. In embodiments, the beam of (laser) light source light may be relatively highly collimated, such as in embodiments ≤2° (FWHM), more especially ≤1° (FWHM), most especially ≤0.5° (FWHM). Hence, ≤2° (FWHM) may be considered (highly) collimated light source light. Optics may be used to provide (high) collimation (see also above).

In embodiments, the light generating system may comprise a first light generating device and a second light generating device. The first light generating device may be configured to generate first device light having a first polarization. Likewise, the second light generating device may be configured to generate second device light having a second polarization. Especially, the second polarization may be different from the first polarization. Furthermore, the control system may be configured to control the first light generating device and the second light generating device. Hence, in a specific embodiment, the light generating system may comprise (i) a first light generating device configured to generate first device light having a first polarization, and (ii) a second light generating device configured to generate second device light having a second polarization, different from the first polarization; wherein the control system may be configured to control the first light generating device and the second light generating device.

The first light generating device and the second light generating device may be configured to generate first and/or second device light having a first and/or second polarization. In embodiments, the first and/or second light generating device may comprise optics for polarizing the respective light source light, or altering the polarization of the respective light source light, to provide polarized first and/or second device light. Especially, the polarized first and/or second device light may essentially have s-polarization and/or p-polarization. Especially, the first and second polarization may be essentially different. For example, in embodiments, the first device light may have s-polarization and the second device light may have p-polarization. Alternatively, in embodiments the first device light may have p-polarization and the second device light may have s-polarization.

In other embodiments, however, the first device light and/or the second device light, may be unpolarized light.

Additionally or alternatively, in other embodiments, the light generating system may comprise more than two types of light generating devices. In such an instance, the one or more first light generating devices may be configured to generate p-polarized device light and the one or more second light generating devices may be configured to generate s-polarized device light (or the other way around).

As can be derived from the above, the term “first light generating devices” may also refer to one or more first light generating devices. Likewise, the term “second light generating devices” may also refer to one or more second light generating devices.

In embodiments, the control system may be configured to control the one or more first light generating devices and the one or more second light generating devices. Especially, in embodiments the control system may be configured to control the polarization of the one or more first light generating devices and the one or more second light generating devices.

In embodiments, the light generating system may comprise a laser bank. Especially, the laser may host a plurality of light generating devices. In embodiments, the laser bank may host the first light generating device and the second light generating device. In such an instance, the first light generating device may comprise a first laser and the second light generating device may comprise a second laser (see also further above).

Additionally or alternatively, in embodiments, the light generating system may comprise a plurality of first and/or second light generating devices comprising a plurality of first and/or second lasers. The plurality of first and/or second light generating devices may be configured in one or more laser banks, such as one laser bank, like two laser banks. For example, in embodiments, the light generating system may comprise a laser bank with the one or more first light generating devices and a separate laser bank with the one or more second light generating devices. In other embodiments, the light generating system may comprise one or more laser banks each with one or more first light generating devices and one or more second light generating device.

The laser bank may especially be configured external of the collimator. In other embodiments, the laser bank may also be configured (at least partially) internal of the collimator.

Further, in embodiments, the light generating system may comprise a polarization control system configured to control the polarization of the device light. The device light may especially be in a state of polarization of light. The polarization control system may especially be configured to change the state of polarization of the device light. Additionally or alternatively, the polarization control system may be configured to control the state of polarization of the device light. For example, in embodiments, the first and second light generating devices may be configured to generate unpolarized light. The polarization control system may be configured to change the unpolarized device light into either p- or s-polarized device light.

In embodiments, the polarization control system may especially be configured (optically coupled) in between the one or more light generating devices and the polarizing beam splitter.

Yet further, in embodiments, the polarization control system may be comprised by the control system, such that the control system may be configured to control the polarization control system.

Additionally or alternatively, in embodiments, the polarization control system may comprise a halfwave plate (or “halfwave retarder”) configured to shift the polarization (direction) of the device light. The halfwave plate may especially have a controllable rotation of a fast axis, which may be controlled by the polarization control system. Halfwave plates are known in the art. Especially, a halfwave plate may comprise a birefringent material. A halfwave plate may especially comprise a material selected from the group of a (crystalline) quartz, a mica, a calcite, and a plastic.

In embodiments, the optics arrangement may comprise (i) a polarizing beam splitter configured in the collimator, and (ii) a retarder arrangement. Additionally or alternatively, in embodiments, the optics arrangement may comprise optics such as a lens, an isolator, an attenuator, a polarization rotator, etc. etc. However, the optics arrangement may in particular comprise a polarizing beam splitter, especially configured in the collimator, and a retarder arrangement. The polarizing beam splitter may be configured in a light receiving relationship with the one or more light generating devices. Especially, the polarizing beam splitter may be configured to (i) direct at least part of received device light in the direction of the first luminescent body or the second luminescent body when the device light has a first polarization, and (ii) to at least part of direct received device light to the retarder arrangement when the device light has a second polarization. More especially, the second polarization may be different from the first polarization. In such an instance, the other one of the first luminescent body and the second luminescent body may be configured in a light receiving relationship with one of more light generating devices via the retarder arrangement and the polarizing beam splitter. Especially, in embodiments, the other one of the first luminescent body and the second luminescent body may be configured to receive at least part of device light having the second polarization. Hence, in a specific embodiment, the optics arrangement may comprise (i) a polarizing beam splitter, configured in the collimator, and (ii) a retarder arrangement, wherein: the polarizing beam splitter may be configured in a light receiving relationship with the one or more light generating devices; wherein the polarizing beam splitter may be configured to (i) direct at least part of received device light in the direction of the first luminescent body or the second luminescent body when the device light has a first polarization, and (ii) to direct at least part of received device light to the retarder arrangement when the device light has second polarization; wherein the other one of the first luminescent body and the second luminescent body may be configured in a light receiving relationship with the one or more light generating devices via the retarder arrangement and the polarizing beam splitter. The retarder arrangement may be configured in the collimator or external thereof.

Especially, in embodiments, the polarizing beam splitter may be configured in a light receiving relationship, i.e. it may be optically coupled, with the one or more light generating devices. More especially, the polarizing beam splitter may be configured to direct at least part of received device light with a first polarization in the direction of the first or second luminescent body. Hence, in embodiments, device light may be directed to the respective luminescent bodies in dependence of the polarization of the device light. In specific embodiments, the polarizing beam splitter, comprised by the optics arrangement, may be configured to direct at least part of device light with a first polarization, especially s-polarized device light, to the first luminescent body.

In embodiments, the polarizing beam splitter may comprise a reflective polarizer.

Additionally or alternatively, in specific embodiments, the polarizing beam splitter may be configured to direct at least part of received device light with a second polarization to the retarder arrangement. Thus, in such an embodiment, the second luminescent body may especially be configured in a light receiving relationship with the one or more light generating devices via the retarder arrangement and the polarizing beam splitter. Furthermore, in such an embodiment, the second luminescent body may be configured to receive at least part of device light having the second polarization. Especially, the polarizing beam splitter may be configured to transmit device light with a second polarization, especially p-polarized device light. Hence the device light with the second polarization may pass through the polarizing beam splitter towards the retarder arrangement. The retarder arrangement may, in embodiments, redirect the incident device light back towards the polarizing beam splitter. In turn, in such an instance, the polarizing beam splitter may redirect the incident device light towards the second luminescent body.

Hence, the second polarization may be essentially different from the first polarization. Especially, in particular embodiments, the second polarization may be p-polarization and the first polarization may be s-polarization.

In further embodiments, the retarder arrangement may comprise a retarder. The retarder may especially comprise a quarter wave plate. Further, in embodiments, the retarder arrangement may comprise a second reflector. The retarder arrangement may especially be configured external of the collimator. The retarder arrangement may also be configured (at least partially) internal of the collimator. Hence, in a specific embodiment, the optics arrangement may comprise a retarder arrangement, wherein the retarder arrangement may comprise (i) a retarder, wherein the retarder comprises a quarter wave plate, and (ii) a second reflector; wherein the retarder arrangement may be configured external of the collimator.

As known from the art, a waveplate or retarder is an optical device that alters the polarization state of a light wave travelling through it. A halfwave plate may shift the polarization direction of linearly polarized light (especially from s to p or from p to s polarization), and a quarter-wave plate may convert linearly polarized light into circularly polarized light (and vice versa).

The retarder may, in embodiments, comprise a quarter wave plate. The quarter wave plate may be configured to phase shift the device light, especially to produce a λ/4 phase shift of the device light. In other embodiments, the retarder may comprise a halfwave plate (λ/2), a full-wave (or “sensitive-tint”) plate (λ), a multiple-order waveplate, or a zero-order waveplate.

Especially, in embodiments, the retarder may comprise a birefringent material, such as one or more materials selected from the group comprising a (crystalline) quartz, a mica, a calcite, a plastic, or a 3D printed material.

Further, the retarder arrangement may comprise a second reflector. The second reflector may provide specular reflection. Yet further, in embodiments, the second reflector may comprise a metallic coating, especially a coating having a high specular reflectivity. For instance, the metallic coating may be an aluminum coating or a silver coating. In a specific embodiment, such metal coating may be covered with a transparent material to protect the metal from aging. Alternatively, in embodiments, the second reflector may comprise an interference coating having a high specular reflectivity. Especially, the interference coating may consist of a stack of transparent layers having alternated refractive indices. In this way, a reflective surface may be obtained.

Yet further, in particular embodiments, the retarder arrangement may be configured external of the collimator. In other embodiments, the retarder arrangement may also be configured (at least partially) internal of the collimator.

In embodiments, where the collimator comprises a hollow reflector, the collimator may comprise a collimator wall. In such embodiments, for example, the retarder arrangement may be configured enclosed by the collimator wall, especially, the second reflector may be comprised by the collimator wall.

In embodiments where the collimator comprises a TIR reflector, the collimator may comprise a massive body. In such embodiments, the retarder arrangement may be configured inside the (optical) cavity (at the first side) of the TIR reflector. Additionally or alternatively, the second reflector may be configured inside the (optical) cavity of the TIR reflector. In a specific embodiment, the second reflector may close off the (optical) cavity. Hence, in such an embodiment, the second reflector may form the first end of the TIR reflector collimator.

In other embodiments, the one or more light generating devices may be configured external of the collimator. The collimator may comprise a collimator wall. Especially, the collimator wall may taper in a direction from the second end to the first end (see also above). Further, in embodiments, the collimator wall may comprise a (small) first opening configured between the one or more light generating devices and the polarizing beam splitter. Yet further, in embodiments, the collimator wall may also comprise a (small) second opening configured between the polarizing beam splitter and the retarder arrangement. Hence, in a specific embodiment, the one or more light generating devices may be configured external of the collimator; wherein the collimator may comprise a collimator wall, wherein the collimator wall may taper in a direction from the second end to the first end; wherein the collimator wall may comprise a first opening configured between the one or more light generating devices and the polarizing beam splitter; and wherein the collimator wall may comprise a second opening configured between the polarizing beam splitter and the retarder arrangement.

The one or more light generating devices may be configured external of the collimator. However, in other embodiments, the one or more light generating devices may (at least partially) be configured internal of the collimator. Especially, however, the one or more light generating devices may be configured external of the collimator.

Hence, the collimator may comprise a collimator wall, especially the collimator wall may be a hollow reflector. The collimator wall may especially be tapered. For example, in embodiments, the collimator wall may be conically shaped. More especially, in embodiments, the collimator wall may taper in a direction from the second end to the first end (see also above). In embodiments, the collimator wall may comprise a first opening. The first opening may especially be a small opening, i.e. the first opening may have cross-sectional dimensions (or a diameter) of at most 10 mm, such as at most 25 mm, like at most 50 mm. In other embodiments, the first opening may be a larger opening. In embodiments, the collimator may comprise a compound parabolic mirror or a compound parabolic reflector.

Hence, the collimator wall may comprise a first opening. In embodiments, the first opening may be configured between the one or more light generating devices and the polarizing beam splitter. Hence, the first opening may be configured such, the polarizing beam splitter may receive device light from the one or more light generating devices (external of the collimator).

In embodiments, the collimator wall may comprise a second opening. The second opening may especially be a small opening, i.e. the second opening may have cross-sectional dimensions (or a diameter) of at most 20 mm, such as at most 10 mm, such as selected from the range of 0.1-5 mm. In other embodiments, the second opening may be a larger opening.

Hence, the collimator wall may comprise a second opening. In embodiments, the second opening may be configured between the polarizing beam splitter and the retarder arrangement. Hence, the second opening may be configured such, the retarder arrangement (external of the collimator) may receive (and reflect) device light from (and to) the polarizing beam splitter.

The first opening and the second opening may, in embodiments, especially be configured essentially opposite each other in the collimator wall. However, in other embodiments, the first opening and the second opening may be configured not opposite each other. In such an instance, a beam of device light may be directed from the first opening to the second opening through the use of for example mirrors or reflectors.

In embodiments, the first opening and the second opening may be a slit or a circular opening, or any other shape. The first opening and the second opening may, in embodiments, have the same shape. However, in other embodiments, the first opening and the second opening may have a different shape. Likewise, the first opening and the second opening may, in embodiments, have the same size. However, in other embodiments, the first opening and the second opening may have a different size.

Additionally or alternatively, in embodiments, the collimator may comprise a TIR reflector. In such embodiments, the one or more light generating devices may be configured external of the TIR reflector. Further, the TIR reflector may taper in a direction form the second end to the first end. Yet further, the TIR reflector may comprise a first opening especially configured between the one or more light generating devices and the polarizing beam splitter. Yet further, the TIR reflector may comprise a second opening especially configured between the polarizing beam splitter and the retarder arrangement.

In embodiments, the different luminescent bodies may be irradiated by device light having different polarizations. Hence, the optical pathway to the different luminescent bodies may at least depend upon the polarization of the device light. In such embodiments, the device light irradiating the first luminescent body and the device light irradiating the second luminescent body may have identical spectral power distributions (though this is not necessarily the case), but may especially have different polarization (such as s-polarization or p-polarization). For instance, a reflective polarizer may be applied.

In embodiments, the different luminescent bodies may be irradiated by device light via at least two beams of light propagating via different optical pathways. A reflective face may direct device light from one direction to one of the luminescent bodies and (another) reflective face may direct the device light from another direction to the other one of the luminescent bodies. In such embodiments, the device light irradiating the first luminescent body and the device light irradiating the second luminescent body may have identical spectral power distributions but may also have different spectral power distributions. The polarization may be the same or may be different. For instance, one or more mirrors may be applied.

In embodiments, the different luminescent bodies may be irradiated by device light having different spectral power distributions. Hence, the optical pathway to the different luminescent bodies at least depends upon the spectral power distribution of the device light. In such embodiments, the device light irradiating the first luminescent body and the device light irradiating the second luminescent body will have different spectral power distributions. For instance, a dichroic mirror may be applied.

As discussed above, the light generating system may be configured to provide system light. In an operational mode, the light generating system may provide a first beam of system light. In another operational mode, the light generating system may provide a second beam of system light. In embodiments, the first luminescent body and the collimator may be configured such that a first beam of system light may have a first beam angle β1. The first beam of system light may especially comprise first luminescent material light. Further, in embodiments the first beam angle β1 may be defined by a full width half maximum of at maximum 2°. Yet further, the second luminescent body and the collimator may be configured such that a second beam of system light may have a second beam angle β2. The second beam of system light may especially comprise second luminescent material light. Further, in embodiments the second beam angle β2 may be defined by a full width half maximum of at minimum 5°. Especially, the system light may escape from the collimator (essentially only) via the second side. Hence, in embodiments, the first beam angle β1 of the first beam of system light may be defined by a full width half maximum, especially by the full width half maximum of at maximum 3°, such as at maximum 2°, like at maximum 1°, especially at maximum 0.5°. In embodiments, the first luminescent body and the collimator may be configured such as to provide the first beam of system light as described herein. In particular, the first luminescent body and the collimator may convert and redirect the device light to provide the first beam of system light. Such maximum values of the full width half maximum of the first beam angle β1 of the first beam of system light may especially be desired for stage-lighting purposes.

Furthermore, in embodiments, the second beam angle β2 of the second beam of system light may be defined by a full width half maximum, especially by the full width half maximum of at minimum 5°, such as preferably at minimum 10°, like preferably at minimum 15°, especially preferably at minimum 20°. In embodiments, the second luminescent body and the collimator may be configured such as to provide the second beam of system light as described herein. In particular, the second luminescent body and the collimator may convert and redirect the device light to provide the second beam of system light. Hence, especially β1<β2. For instance, in embodiments β1/β2≤0.5, such as, in embodiments β1/β2≤0.1.

Hence, the first luminescent body, the second luminescent body and the collimator may be configured to provide dynamic beam shaping. Especially, the control system may control the light generating system to provide dynamic beam shaping. In embodiments, irradiation of the first luminescent body may result in a first beam of system light, especially a narrow beam of system light. Especially, irradiation of the first luminescent body may provide room for reflection of the luminescent material light on the collimator wall. Such reflection may result in collimation of the light, i.e. may result in a narrow first beam of system light. In other embodiments, irradiation of the second luminescent body may result in a second beam of system light, especially a broad second beam of system light. Especially, irradiation of the second luminescent body may provide less room for reflection of the luminescent material light on the collimator wall. Hence, irradiation of the second luminescent body may result in less collimation of the light, i.e. may result in a broad second beam of system light.

Hence, dynamic beam shaping may be provided.

The differently positioned first luminescent body and the second luminescent body may result in different spatial light distributions of the system light. In embodiments, in a first operational mode and in a second operational mode the relative contributions of the first luminescent body and the second luminescent body may be varied.

The control system may be configured to switch between the first operational mode and the second operational mode. The system may be configured to provide a first beam of system light in the first operational mode. Especially, the first beam of system light may have a first spatial light distribution. Hence, in the first operational mode, the relative contribution of the first luminescent body may be higher. The system may also be configured to provide a second beam of system light in the second operational mode. Especially, the second beam of system light may have a second spatial light distribution. Hence, in the second operational mode, the relative contribution of the second luminescent body may be higher.

In embodiments, the control system may be configured to switch between a working light mode and an ambience light mode. For example, a working light mode may, in embodiments, be provided by the first operational mode. Hence, a narrow first beam of system light may be useful for a working light mode. Further, an ambience light mode may, in embodiments, be provided by the second operational mode. Hence, a broad second beam of system light may be useful for an ambience light mode.

In embodiments, the one or more light generating devices, the first luminescent body, and the second luminescent body may be selected and configured such that the spatial and/or spectral properties of the system light may depend upon the polarization of the device light. In such instance, especially spectral properties selected from color point and correlated color temperature of the system light may depend upon the polarization of the device light.

The system light may have spatial properties such as beam angle and beam shape. Furthermore, the system light may also have spectral properties, such as intensity, color point and correlated color temperature (see also further below). In embodiments, the spatial properties of the system light may depend upon the polarization of the device light. In further embodiments, the spectral properties of the system light may depend upon the polarization of the device light.

In an operational mode, the system may, in embodiments, be configured to generate white light. In such an instance, in embodiments blue (laser) light may be combined with (yellow) phosphor converted light to produce white light. Hence, the light generating device may be configured to generate blue (laser) device light, whereas simultaneously the first and/or second luminescent body may be configured to convert part of that blue (laser) device light into (yellow) luminescent material light. Hence, especially, the system light comprises both (yellow) luminescent material light and unconverted (blue) device light.

In specific embodiments, the luminescent material may be selected such, that the system light may be warm white light or cold white light. Especially, in specific embodiments, the first luminescent material may be selected such, that the first operational mode may result in a narrow first beam of cool white system light. Such a beam of system light may especially be useful for creating a working light mode. Further, in such specific embodiments, the second luminescent material may be selected such, that the second operational mode may result in a broad second beam of warm white system light. Such a beam of system light may especially be useful for creating an ambience light mode.

In other embodiments, the system may be configured to generate colored light in an operational mode. In yet further embodiments, the system may be configured to generate white light in one or more operational modes and colored light in one or more other operational modes. Hence, a plurality of different operational modes with a plurality of differently shaped and colored beams of light may be possible.

The term “white light”, and similar terms, herein, are known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70.

In embodiments, the first luminescent body may comprise a first luminescent material. Likewise, the second luminescent body may comprise a second luminescent material. Especially, in embodiments, the first luminescent material and the second luminescent material may be different. Furthermore, the first luminescent material and the second luminescent material may comprise a luminescent material of the type A₃B₅O₁₂:Ce, wherein may A in embodiments comprise one or more of Y, La, Gd, Tb and Lu, and wherein B may in embodiments comprise one or more of Al, Ga, In and Sc. In embodiments, A may especially comprise (at least) one or more of Y, Gd, Tb and Lu. Additionally or alternatively, in embodiments, B may especially comprise at least one or more of Al and Ga. Hence, in a specific embodiment, the first luminescent body may comprise a first luminescent material, and the second luminescent body may comprise a second luminescent material, wherein the first luminescent material and the second luminescent material may be different; wherein at least one of the first luminescent material and the second luminescent material may comprise a luminescent material of the type A₃B₅O₁₂:Ce, wherein A in embodiments comprises one or more of Y, La, Gd, Tb and Lu, and wherein B in embodiments comprises one or more of Al, Ga, In and Sc.

In embodiments, both the first and the second luminescent body may comprise a luminescent material from the type A₃B₅O₁₂:Ce. In such embodiments, the first and second luminescent body may especially comprise a different composition of elements A and B.

In other embodiments, the first and/or the second luminescent body may comprise a combination of different luminescent materials, especially including a luminescent material of the type A₃B₅O₁₂:Ce. In such embodiments, the first and second luminescent body may be essentially not identical, i.e. the first and second luminescent body may comprise a different combination of luminescent materials.

In yet other embodiments, only one of the first and the second luminescent body may comprise a luminescent material from the type A₃B₅O₁₂:Ce.

As indicated above, the light generating system especially comprises a first and a second luminescent body comprising first and second luminescent material configured to convert at least part of the light source light into (first and/or second) luminescent material light. Hence, especially the first and/or second luminescent material is or comprises a converter element.

The term “luminescent material” herein especially relates to inorganic luminescent materials, which are also sometimes indicated as phosphors. These terms are known to the person skilled in the art.

The term “luminescent material” further refers to a material that can convert first radiation, especially (one or more of UV radiation and) blue radiation, into second radiation. In general, the first radiation and second radiation have different spectral power distributions. Hence, instead of the term “luminescent material”, also the terms “luminescent converter” or “converter” may be applied. In general, the second radiation has a spectral power distribution at larger wavelengths than the first radiation, which is the case in the so-called down-conversion. In specific embodiments, however the second radiation has a spectral power distribution with intensity at smaller wavelengths than the first radiation, which is the case in the so-called up-conversion. In embodiments, the “luminescent material” may especially refer to a material that can convert radiation into e.g. visible and/or infrared light. For instance, in embodiments the luminescent material may be able to convert one or more of UV radiation and blue radiation, into visible light. The luminescent material may in specific embodiments also convert radiation into infrared radiation (IR). Hence, upon excitation with radiation, the luminescent material emits radiation. In general, the luminescent material will be a down converter, i.e. radiation of a smaller wavelength is converted into radiation with a larger wavelength (λₑₓ<λₑₘ), though in specific embodiments the luminescent material may comprise down-converter luminescent material, i.e. radiation of a larger wavelength is converted into radiation with a smaller wavelength (λₑₓ>λₑₘ). In embodiments, the term “luminescence” may refer to phosphorescence. In embodiments, the term “luminescence” may also refer to fluorescence. Instead of the term “luminescence”, also the term “emission” may be applied. Hence, the terms “first radiation” and “second radiation” may refer to excitation radiation and emission (radiation), respectively. Likewise, the term “luminescent material” may in embodiments refer to phosphorescence and/or fluorescence. The term “luminescent material” may also refer to a plurality of different luminescent materials. The term “luminescent material” herein may also refer to a material comprising a luminescent material, such as a light transmissive host comprising the luminescent material.

Especially, the luminescent material is configured to convert at least part of the light source light into luminescent material light, wherein the luminescent material may comprise a (garnet) luminescent material of the type A₃B₅O₁₂:Ce, wherein A comprises one or more of Y, La, Gd, Tb and Lu, and wherein B comprises one or more of Al, Ga, In and Sc. Hence, the luminescent material light may e.g. be green light or yellow light (or in specific embodiments even orange (dependent upon the composition of the garnet and cerium concentration)). However, other embodiments are also possible, see below. In embodiments, 0.05-10% of the A elements comprise Ce, even more especially 0.05-5%, such as 0.1-5%. Especially, embodiments, 0.1-3% of the A elements comprise Ce, such as up to 2%, like selected from the range of 0.1-1.5%, such as at least above 0.5%.

Especially, a luminescent material comprises conversion material or is a conversion material. A luminescent material converts light from a light source, such as the light source light, into secondary light (here the luminescent material light). The luminescent material may comprise an organic group that converts the light, or a molecule that converts the light, or an inorganic group that converts the light, etc. Such groups (or molecule) may be indicated as converter element. The garnet type material as indicated above, comprises cerium (Ce) as converter element. Cerium comprising garnets are well known in the art.

Hence, in specific embodiments the luminescent material comprises a luminescent material of the type A₃B₅O₁₂:Ce, wherein A in embodiments comprises one or more of Y, La, Gd, Tb and Lu, especially (at least) one or more of Y, Gd, Tb and Lu, and wherein B in embodiments comprises one or more of Al, Ga, In and Sc. Especially, A may comprise one or more of Y, Gd and Lu, such as especially one or more of Y and Lu. Especially, B may comprise one or more of Al and Ga, more especially at least Al, such as essentially entirely Al. Hence, especially suitable luminescent materials are cerium comprising garnet materials. Embodiments of garnets especially include A₃B₅O₁₂ garnets, wherein A comprises at least yttrium or lutetium and wherein B comprises at least aluminum. Such garnets may be doped with cerium (Ce), with praseodymium (Pr) or a combination of cerium and praseodymium; especially however with Ce. Especially, B comprises aluminum (Al), however, B may also partly comprise gallium (Ga) and/or scandium (Sc) and/or indium (In), especially up to about 20% of Al, more especially up to about 10 % of Al (i.e. the B ions essentially consist of 90 or more mole % of Al and 10 or less mole % of one or more of Ga, Sc and In); B may especially comprise up to about 10% gallium. In another variant, B and O may at least partly be replaced by Si and N. The element A may especially be selected from the group consisting of yttrium (Y), gadolinium (Gd), terbium (Tb) and lutetium (Lu). Further, Gd and/or Tb are especially only present up to an amount of about 20% of A. In a specific embodiment, the garnet luminescent material comprises (Y₁₋ₓLuₓ)₃B₅O₁₂:Ce, wherein x is equal to or larger than 0 and equal to or smaller than 1. The term “:Ce”, indicates that part of the metal ions (i.e. in the garnets: part of the “A” ions) in the luminescent material is replaced by Ce. For instance, in the case of (Y₁₋ₓLuₓ)₃Al₅O₁₂:Ce, part of Y and/or Lu is replaced by Ce. This is known to the person skilled in the art. Ce will replace A in general for not more than 10%; in general, the Ce concentration will be in the range of 0.1 to 4%, especially 0.1 to 2% (relative to A). Assuming 1% Ce and 10% Y, the full correct formula could be (Y_{0.1}Lu_{0.89}Ce_{0.01})₃Al₅O₁₂. Ce in garnets is substantially or only in the trivalent state, as is known to the person skilled in the art.

In embodiments, the luminescent material (thus) comprises A₃B₅O₁₂ wherein in specific embodiments at maximum 10% of B—O may be replaced by Si—N.

In specific embodiments the luminescent material comprises (Yₓ₁₋ₓ₂₋ₓ₃A′ₓ₂Ceₓ₃)₃(Al_{y1-y2}B′_{y2})₅O₁₂, wherein x1+x2+x3=1, wherein x3>0, wherein 0<x2+x3≤0.2, wherein y1+y2=1, wherein 0≤y2≤0.2, wherein A′ comprises one or more elements selected from the group consisting of lanthanides, and wherein B′ comprises one or more elements selected from the group consisting of Ga, In and Sc. In embodiments, x3 is selected from the range of 0.001-0.1. In the present invention, especially x1>0, such as >0.2, like at least 0.8. Garnets with Y may provide suitable spectral power distributions.

In specific embodiments at maximum 10% of B—O may be replaced by Si—N. Here, B in B—O refers to one or more of Al, Ga, In and Sc (and O refers to oxygen); in specific embodiments B—O may refer to Al—O. As indicated above, in specific embodiments x3 may be selected from the range of 0.001-0.04. Especially, such luminescent materials may have a suitable spectral distribution (see however below), have a relatively high efficiency, have a relatively high thermal stability, and allow a high CRI (in combination with the light source light and the second light source light (and the optical filter)). Hence, in specific embodiments A may be selected from the group consisting of Lu and Gd. Alternatively or additionally, B may comprise Ga. Hence, in embodiments the luminescent material comprises (Yₓ₁₋ₓ₂₋ₓ₃(Lu,Gd)ₓ₂Ceₓ₃)₃(Al_{y1-y2}Ga_{y2})₅O₁₂, wherein Lu and/or Gd may be available. Even more especially, x3 is selected from the range of 0.001-0.1, wherein 0<x2+x3≤0.1, and wherein 0≤y2≤0.1. Further, in specific embodiments, at maximum 1% of B—O may be replaced by Si—N. Here, the percentage refers to moles (as known in the art); see e.g. also EP3149108. In yet further specific embodiments, the luminescent material comprises (Yₓ₁₋ₓ₃Ceₓ₃)₃Al₅O₁₂, wherein x1+x3=1, and wherein 0<x3≤0.2, such as 0.001-0.1.

In specific embodiments, the light generating device may only include luminescent materials selected from the type of cerium comprising garnets. In even further specific embodiments, the light generating device includes a single type of luminescent materials, such as (Yₓ₁₋ₓ₂₋ₓ₃A′ₓ₂Ceₓ₃)₃(Al_{y1-y2}B′_{y2})₅O₁₂. Hence, in specific embodiments the light generating device comprises luminescent material, wherein at least 85 weight %, even more especially at least about 90 wt. %, such as yet even more especially at least about 95 weight % of the luminescent material comprises (Yₓ₁₋ₓ₂₋ₓ₃A′ₓ₂Ceₓ₃)₃(Al_{y1-y2}B′_{y2})₅O₁₂. Here, wherein A′ comprises one or more elements selected from the group consisting of lanthanides, and wherein B′ comprises one or more elements selected from the group consisting of Ga In and Sc, wherein x1+x2+x3=1, wherein x3>0, wherein 0<x2+x3≤0.2, wherein y1+y2=1, wherein 0≤y2≤0.2. Especially, x3 is selected from the range of 0.001-0.1. Note that in embodiments x2=0. Alternatively or additionally, in embodiments y2=0.

In specific embodiments, A may especially comprise at least Y, and B may especially comprise at least Al.

The garnet type luminescent material may also described with an alternative formula A₃B′₂C″₃O₁₂. Here, A may comprise one or more of (i) rare earth ions, such as one or more selected from Y³⁺, Lu³⁺, Gd³⁺, Tb³⁺, La³⁺, and (ii) divalent cations, such as Ca²⁺. Here, B may comprise one or more of (i) trivalent cations, such as one or more of Al³⁺, Ga³⁺, Sc³⁺, Sb³⁺, and In³⁺, and (ii) divalent cations, such as one or more of Mg²⁺ and Mn²⁺. Here, C may comprise one or more of (i) trivalent cations, such as one or more of Ga³⁺ and Al³⁺, (ii) divalent cations, such as Mn²⁺, and (iii) tetravalent cations, such as one or more of Si⁴⁺ and Ge⁴⁺. With such ions, the garnet crystal structure can be maintained. Other substitutions than mentioned may also be possible.

Alternatively or additionally, the luminescent material may e.g. be M₂Si₅N₈:Eu²⁺ and/or MAlSiN₃:Eu²⁺ and/or Ca₂AlSi₃O₂N₅:Eu²⁺, etc., wherein M comprises one or more of Ba, Sr and Ca, especially in embodiments at least Sr. In specific embodiments, the first luminescent may comprise one or more materials selected from the group consisting of (Ba,Sr,Ca)S:Eu, (Ba,Sr,Ca)AlSiN₃:Eu and (Ba,Sr,Ca)₂Si₅N₈:Eu. In these compounds, europium (Eu) is substantially or only divalent, and replaces one or more of the indicated divalent cations. In general, Eu will not be present in amounts larger than 10% of the cation; its presence will especially be in the range of about 0.5 to 10%, more especially in the range of about 0.5 to 5% relative to the cation(s) it replaces. The term “:Eu”, indicates that part of the metal ions is replaced by Eu (in these examples by Eu²⁺). For instance, assuming 2% Eu in CaAlSiN₃:Eu, the correct formula could be (Ca_{0.98}Eu_{0.02})AlSiN₃. Divalent europium will in general replace divalent cations, such as the above divalent alkaline earth cations, especially Ca, Sr, or Ba. The material (Ba,Sr,Ca)S:Eu can also be indicated as MS:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca). Further, the material (Ba,Sr,Ca)₂Si₅N₈:Eu can also be indicated as M₂Si₅N₈:Eu, wherein M is one or more elements selected from the group consisting of barium (Ba), strontium (Sr) and calcium (Ca); especially, M comprises in this compound Sr and/or Ba. In a further specific embodiment, M consists of Sr and/or Ba (not taking into account the presence of Eu), especially 50 to 100%, more especially 50 to 90% Ba and 50 to 0%, especially 50 to 10% Sr, such as Ba_{1.5}Sr_{0.5}Si₅N₈:Eu (i.e. 75% Ba; 25% Sr). Here, Eu is introduced and replaces at least part of M, i.e. one or more of Ba, Sr, and Ca). Likewise, the material (Ba,Sr,Ca)AlSiN₃:Eu can also be indicated as MAlSiN₃:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca). Eu in the above indicated luminescent materials is substantially or only in the divalent state, as is known to the person skilled in the art. Hence, such nitride luminescent materials may also be or comprise converter elements, here especially Eu²⁺.

Especially, the luminescent material may be an inorganic luminescent material, such as one or more of the above-described trivalent cerium or divalent europium comprising oxides, oxynitrides, or nitrides.

The luminescent material is configured to convert at least part of first radiation (selected from one or more of UV radiation and visible radiation), into luminescent material light. Especially, in embodiments the luminescent material may be configured to convert at least part of blue light (as radiation) into luminescent material light. Especially when blue light is partly converted, the blue light may be used as source of blue light (for the device light) and as excitation light that can be converted by the luminescent material. The first radiation may especially be provided by a (solid state) light source.

When different luminescent materials are applied, one or more luminescent materials may be configured to convert laser light source light into one or more of green and yellow luminescent material light, and one or more other luminescent materials may be configured to convert laser light source light into one or more of orange and red luminescent material light.

In specific embodiments, the luminescent body comprises a ceramic body comprising the luminescent material. Ceramic bodies are known in the art. Alternatively, the luminescent body comprises single crystal. In yet further specific embodiments, different types of luminescent bodies may be applied. Hence, the body may especially be selected from single crystalline bodies and ceramic bodies. The latter may be more easily made than the former, while they nevertheless may have good optical and/or thermal properties. Hence, in embodiments the body may be a ceramic body. However, in specific embodiments also a combination of single crystalline bodies and ceramic bodies may be applied. Especially, the luminescent body comprises a ceramic luminescent body. Hence, in specific embodiments the luminescent body is defined by a ceramic luminescent material. Therefore, in specific embodiments the luminescent material is a luminescent material that can be provided a ceramic luminescent body. Hence, the luminescent body may comprise a ceramic luminescent body.

Hence, in embodiments, at least one of the first luminescent body and the second luminescent body may comprise a luminescent material of the type A₃B₅O₁₂:Ce.

In embodiments, one or more of the following may apply to the light generating system: (a) the first luminescent body may be configured to absorb part of the device light, to convert it into first luminescent material light, and to reflect or transmit (another) part of the device light; and (b) the second luminescent body may be configured to absorb part of the device light, to convert it into second luminescent material light, and to reflect or transmit (another) part of the device light. Further, in embodiments, the system light may comprise unconverted device light. Especially unconverted device light reflected at or transmitted by the first luminescent body and/or unconverted device light reflected at or transmitted by the second luminescent body. Hence, in embodiments, the system light may comprise blue unconverted device light and (yellow) luminescent material light, i.e. the system light may be white light.

In embodiments, the first luminescent body may be configured to absorb part of the device light and convert it into first luminescent material light. In such embodiments the first luminescent body may also be configured to reflect or transmit (another) part of the device light. For example, in such an embodiment, the first luminescent body may be configured to absorb and convert s-polarized device light, whereas it may be configured to reflect or transmit p-polarized device light.

In further embodiments, the second luminescent body may be configured to absorb part of the device light and convert it into second luminescent material light. In such embodiments, the second luminescent body may also be configured to reflect or transmit (another) part of the device light. For example, in such an embodiment, the second luminescent body may be configured to absorb and convert s-polarized device light, whereas it may be configured to reflect or transmit p-polarized device light.

In embodiments, the system light may comprise unconverted device light, especially unconverted device light reflected at or transmitted by the first luminescent body. In other embodiments, the system light may comprise unconverted device light, especially unconverted device light reflected at or transmitted by the second luminescent body. In yet other embodiments, the system light may comprise unconverted device light, especially unconverted device light reflected at or transmitted by the first luminescent body and the second luminescent body. Hence, in such embodiments described here, the system light may essentially be blue light.

However, in embodiments, the system light may also comprise first luminescent material light converted by the first luminescent body and/or second luminescent material light converted by the second luminescent body. Hence, in embodiments, the system light may comprise first and second luminescent material light. Additionally or alternatively, the system light may comprise unconverted (blue) device light and first and/or second luminescent material light, i.e. the system light may essentially be white light.

The first and/or second luminescent body may be operated in a transmissive mode or in a reflective mode. Herein, when an element is indicated to be operated in a transmissive mode this may, in embodiments, imply that at one or more wavelengths the part of the radiation that is transmitted may be larger than the part of the radiation that is reflected or absorbed. Herein, when an element is indicated to be operated in a reflective mode this may in embodiments imply that at one or more wavelengths the part of the radiation that is reflected may be larger than the part of the radiation that is transmitted or absorbed. In a specific embodiment, the first luminescent body may be operated in the transmissive mode and the second luminescent body may be operated in the transmissive mode. However, in another embodiment, the first luminescent body may be operated in the reflective mode and the second luminescent body may be operated in the reflective mode. In yet another embodiment, the first luminescent body may be operated in the reflective mode and the second luminescent body may be operated in the transmissive mode. In yet another embodiment, the first luminescent body may be operated in the transmissive mode and the second luminescent body may be operated in the reflective mode. Especially, in embodiments the first luminescent body may be operated in the reflective mode and the second luminescent body may be operated in the reflective mode.

In particular embodiments, the first luminescent body and the second luminescent body may both be operated in the reflective mode. This may be beneficial to the heat sinking capacity of the light generating system.

In embodiments, the system light may have a controllable correlated color temperature. The controllable correlated color temperatures may include color temperatures differing at least 1000 K in dependence of the polarization of the device light. Especially, in embodiments, the first beam of system light may have a correlated color temperature of at least 7000 K. In such embodiments, the second beam of system light may have a correlated color temperature of at maximum 4000 K.

The system light may have a correlated color temperature (see also above).

The control system may, in embodiments, be configured to control the correlated color temperature of the system light. The correlated color temperature of the system light may, for example, be controlled by controlling the polarization of the device light, i.e. by controlling what luminescent body the device light is directed to. Hence, the system light may have a controllable correlated color temperature. In embodiments, the controllable correlated color temperatures of the system light may especially include correlated color temperature differing at least 1000 K in dependence of the polarization of the device light, such as at least 1500 K, like at least 2000 K, especially at least 3000 K, more especially at least 4000 K. Hence, the polarization of the device light may have an impact on the correlated color temperature of the system light.

In embodiments, the first beam of system light may have a correlated color temperature in the range of 6000-20000 K, such as in the range of 7000-15000 K, especially in the range of 8000-12000 K. The first beam of system light may especially have a correlated color temperature of at least 7000 K, such as at least 8000 K, like at least 9000 K, especially at least 10000 K. Hence, in embodiments, the first beam of system light may be a cool colored (i.e. blue(ish)) beam of system light.

In further embodiments, the second beam of system light may have a correlated color temperature in the range of 2200-5000 K, such as in the range of 2500-4000 K, especially in the range of 2700-3700 K. The first beam of system light may especially have a correlated color temperature of at most 4000 K, such as at most 3000 K, like at most 2500 K, especially at most 2200 K. Hence, in embodiments, the first beam of system light may be a warm colored (i.e. yellow(ish)) beam of system light.

In further embodiments, the light generating system may comprise a heat transfer system. The heat transfer system may especially be configured to transfer heat from one or more of the first luminescent body and the second luminescent body.

In embodiments, heat transfer systems may transfer heat between two locations based on both thermal conductivity and phase transition. Especially, the heat transfer system may transfer heat between the first and/or second luminescent body and the ambient environment.

Herein, the heat transfer system may, in embodiments, comprise one or more of a heat pipe, such as a vapor chamber, a heat sink, a fan, and a sapphire substrate. Especially, in embodiments the heat transfer system may comprise one or more of a heat pipe, such as a vapor chamber, and a heat sink.

In particular embodiments, a cooling liquid may turn into vapor by absorbing heat at a heat source, after which it may travel along a heat pipe or a heat sink to a heat exchanger, where the vapor may condense to a liquid and release latent heat.

Heat pipes may be known in the art. The heat transfer system herein may especially comprise one or more heat pipes. The one or more heat pipes may, in embodiments, be rod-shaped. Furthermore, in embodiments, the one or more heat pipes may comprise a material selected from the group comprising copper, steel, aluminum, and an alloy. The heat pipe may further comprise a (volatile) cooling fluid, such as water. Yet further, in embodiments, the one or more heat pipes may be configured such that they may support the first and/or second luminescent body. Especially, the one or more heat pipes may, in embodiments, connect the first and/or second luminescent body to the collimator.

In embodiments, the heat pipe may comprise a vapor chamber. The vapor chamber may comprise a vapor chamber at least partly defined by two parallel configured plates, i.e., in embodiments, the vapor chamber may comprise a first plate and a second plate, especially with a vapor chamber in between. The first plate and the second plate may especially be arranged in parallel. Hence, in embodiments the vapor chamber may be defined by at least a first plate and a second plate having an average plate distance equal to a chamber height, i.e., the first plate and the second plate may define the chamber height. At the edges of the plates, the plates may be welded together to provide a closed chamber. The plates may also define, together with one or more edges, the vapor chamber. In embodiments, over a substantial part of the first plate and a substantial part of the second plate, the plates may be configured parallel. For instance, over at least 50%, such as at least 80%, like at least 90% of an area of the first plate, and over at least 50%, such as at least 80%, like at least 90% of an area of the second plate, the plates may be configured parallel. Hence, over a substantial part of the first plate and a substantial part of the second plate, the distance between the plates may essentially not vary. The first plate and the second plate may especially approximate a (same) rectangular shape, such as a rounded rectangular shape. In particular, the term “parallel” with respect to the parallel configured plates may herein refer to the two plates having essentially the same (closest) distance from one another at over a substantial parts of the plates. Hence, the two plates may, for example, be bent, especially with the same radius of curvature, and still be considered parallel. Hence, in such embodiments, the (elongated) chamber may be the vapor chamber.

In embodiments, the chamber may have a chamber volume of at least (about) 1 mm3, such as at least 0.5 cm3, especially at least (about) 1 cm3, such as at least about 2 cm3, especially at least about 5 cm3, such as about 10 cm3. In embodiments, the chamber volume may be at most (about) 1000 cm3, such as at most 500 cm3, especially at most 100 cm3, such as at most 25 cm3, even more especially at most (about) 10 cm3. In particular, when the chamber volume is large it may further serve as an (auxiliary) heat sink.

A heat sink may (passively) transfer heat generated by the light generating devices to a fluid medium, such as air or a liquid coolant. Hence, the heat may be dissipated away from the light generating devices. In embodiments, the heat transfer system may comprise one or more heat sinks.

Factors such as choice of material, protrusion design and surface treatment may affect the performance of the heat sink. Therefore, in embodiments, the one or more heat sinks may comprise a material selected from the group comprising aluminum, copper, or an alloy. In embodiments, the one or more heat sinks may comprise one or more of a plurality of pins, a plurality of straight fins, a plurality of flared fins, and a combination of the aforementioned.

The heat transfer system may e.g. be configured to transfer heat from one or more of the first luminescent body and the second luminescent body. Heat may be dissipated to the external of the system, e.g. via a heat pipe, such as a vapor chamber, a heat sink, and a sapphire substrate. Alternatively or additionally, a fan may be used to transfer dissipated thermal energy from one or more of the first luminescent body and the second luminescent body. In embodiments, the heat transfer system may thus comprise e.g. one or more heat sinks configured to transfer heat from one or more of the first luminescent body and the second luminescent body.

The heat transfer system may further, in embodiments, comprise a fan, especially a fan selected from the group comprising an axial fan and a centrifugal fan, especially an axial fan, or especially a centrifugal fan. The fan may especially comprise ventilator blades.

In further embodiments, the heat transfer system may comprise a sapphire substrate, i.e. a crystalline Al₂O₃ substrate. Sapphire is a birefringent material and is highly resistant against thermal shocks and high temperatures. Furthermore, sapphire is thermally conductive. Hence, sapphire is widely used as heat-dissipating material. Herein, the sapphire substrate may be used as a heat-dissipating and light-transmitting optical window (or “filter”).

Hence, the heat transfer system may comprise a light transmissive thermally conductive body. The light transmissive thermally conductive material may especially be configured in thermal contact with the second luminescent body. In embodiments, one or more of a heat pipe and a light transmissive thermally conductive body may be configured in thermal contact with the second luminescent body. Especially, the one or more of a heat pipe and a light transmissive conductive body may be configured to support the second luminescent body. More especially, the light transmissive conductive body may be transmissive for one or more of device light, first luminescent material light, second luminescent material light, and system light.

Which luminescent body is irradiated with the device light may be based on polarization, but is not necessarily based on polarization. In embodiments, the device light may be directed to a respective luminescent body because device light may irradiate an optical component, especially a reflector arrangement, from different sides. The reflector arrangement may, in embodiments, comprise one or more reflectors, such as one reflector, especially two reflectors. In further embodiments, the reflector arrangement may comprise one or more reflectors, like including one or more of a double sided reflector, a curved reflector, a prismatic shaped reflector, a reflective polarizer, a dichroic, or a specular reflector. The reflector arrangement may especially be configured in the collimator. For instance, when using one or more optical elements to split a beam of device light in two different beams, and e.g. using a shutter, two different beams can reach the reflector arrangement from different sides. Which luminescent body is irradiated may be controlled with the control system by controlling the shutter. Of course, this may also be obtained when using two light generating devices arranged at different positions. In this way, also two different (e.g. opposite) beams of device light may be generated, which may be easily controlled with the control system by controlling the light generating devices.

Hence, in specific embodiments the optics arrangement may comprise a reflector arrangement, wherein the one or more light generating devices are configured to irradiate the reflector arrangement from different sides of the reflector arrangement. Especially, the one or more light generating devices and the reflector arrangement may be configured to irradiate the first luminescent body and the second luminescent body. Further, in embodiments, the control system may be configured to control which of the luminescent bodies is irradiated by the device light.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In yet a further aspect, the invention also provides a lamp or a luminaire comprising the light generating system as defined herein. The luminaire may further comprise a housing, optical elements, louvres, etc. etc . . . The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also provides a lighting device selected from the group of a lamp, a luminaire, a projector device, a disinfection device, a photochemical reactor, and an optical wireless communication device, comprising the light generating system as defined herein.

The lighting device may comprise a housing or a carrier, configured to house or support, one or more elements of the light generating system. For instance, in embodiments the lighting device may comprise a housing or a carrier, configured to house or support one or more of the one or more light generating devices, the collimator, the control system and the heat transfer system.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to (at least) visible light.

The terms “violet light” or “violet emission”, and similar terms, may especially relate to light having a wavelength in the range of about 380-440 nm. In specific embodiments, the violet light may have a centroid wavelength in the 380-440 nm range. The terms “blue light” or “blue emission”, and similar terms, may especially relate to light having a wavelength in the range of about 440-490 nm (including some violet and cyan hues). In specific embodiments, the blue light may have a centroid wavelength in the 440-490 nm range. The terms “green light” or “green emission”, and similar terms, may especially relate to light having a wavelength in the range of about 490-560 nm. In specific embodiments, the green light may have a centroid wavelength in the 490-560 nm range. The terms “yellow light” or “yellow emission”, and similar terms, may especially relate to light having a wavelength in the range of about 560-590 nm. In specific embodiments, the yellow light may have a centroid wavelength in the 560-590 nm range. The terms “orange light” or “orange emission”, and similar terms, may especially relate to light having a wavelength in the range of about 590-620 nm. In specific embodiments, the orange light may have a centroid wavelength in the 590-620 nm range. The terms “red light” or “red emission”, and similar terms, may especially relate to light having a wavelength in the range of about 620-750 nm. In specific embodiments, the red light may have a centroid wavelength in the 620-750 nm range. The terms “cyan light” or “cyan emission”, and similar terms, especially relate to light having a wavelength in the range of about 490-520 nm. In specific embodiments, the cyan light may have a centroid wavelength in the 490-520 nm range. The terms “amber light” or “amber emission”, and similar terms, may especially relate to light having a wavelength in the range of about 585-605 nm, such as about 590-600 nm. In specific embodiments, the amber light may have a centroid wavelength in the 585-605 nm range. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range.

A light generating device or a light generating system may be configured to generate device light (or “light generating device light”) or system light (“or light generating system light”). As indicated above, the terms light and radiation may interchangeably be used.

The light generating device may comprise a light source. The device light may in embodiments comprise one or more of light source light and converted light source light (such as luminescent material light).

The light generating system may comprise a light source. The system light may in embodiments comprise one or more of light source light and converted light source light (such as luminescent material light).

The term UV radiation may in specific embodiments refer to near UV radiation (NUV). Therefore, herein also the term “(N)UV” is applied, to refer to in general UV, and in specific embodiments to NUV. The term IR radiation may in specific embodiments refer to near IR radiation (NIR). Therefore, herein also the term “(N)IR” is applied, to refer to in general IR, and in specific embodiments to NIR.

Herein, IR (infrared) may especially refer to radiation having a wavelength selected from the range of 780-3000 nm, such as 780-2000 nm, e.g. a wavelength up to about 1500 nm, like a wavelength of at least 900 nm, though in specific embodiments other wavelengths may also be possible. Hence, the term IR may herein refer to one or more of near infrared (NIR (or IR-A)) and short-wavelength infrared (SWIR (or IR-B)), especially NIR.

The term “centroid wavelength”, also indicated as λc, is known in the art, and refers to the wavelength value where half of the light energy is at shorter and half the energy is at longer wavelengths; the value is stated in nanometers (nm). It is the wavelength that divides the integral of a spectral power distribution into two equal parts as expressed by the formula λc=Σλ*I(λ)/(ΣI(λ)), where the summation is over the wavelength range of interest, and I(λ) is the spectral energy density (i.e. the integration of the product of the wavelength and the intensity over the emission band normalized to the integrated intensity). The centroid wavelength may e.g. be determined at operation conditions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-3 schematically depict embodiments of the invention and some general aspects; and

FIG. 4 schematically depicts embodiments of an application.

The schematic drawings are not necessarily to scale.

### DETAILED DESCRIPTION OF THE EMBODIMENTS

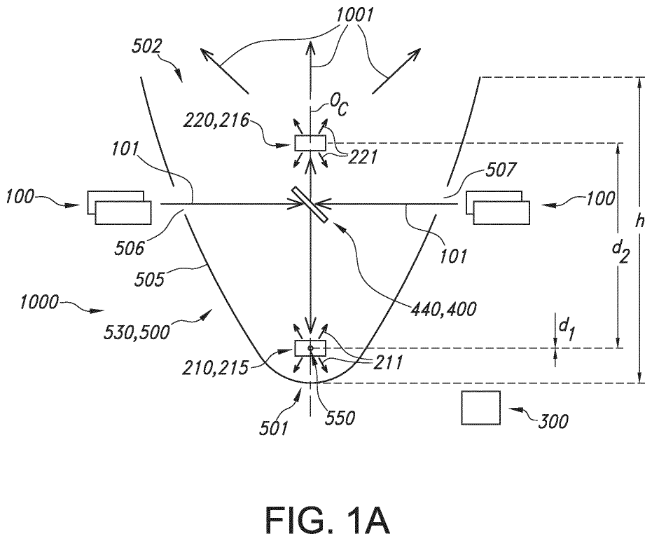

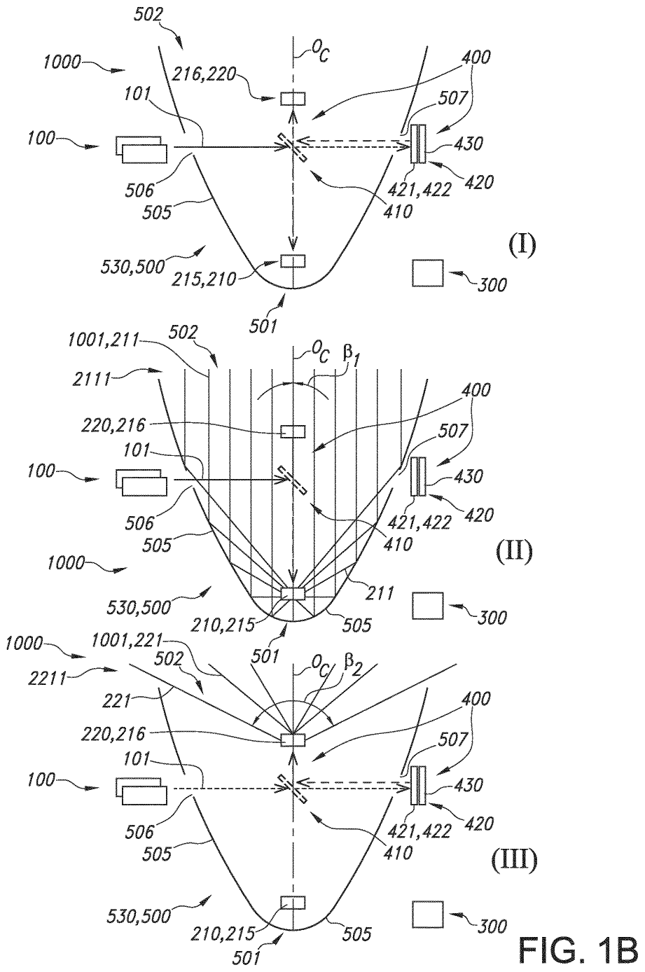

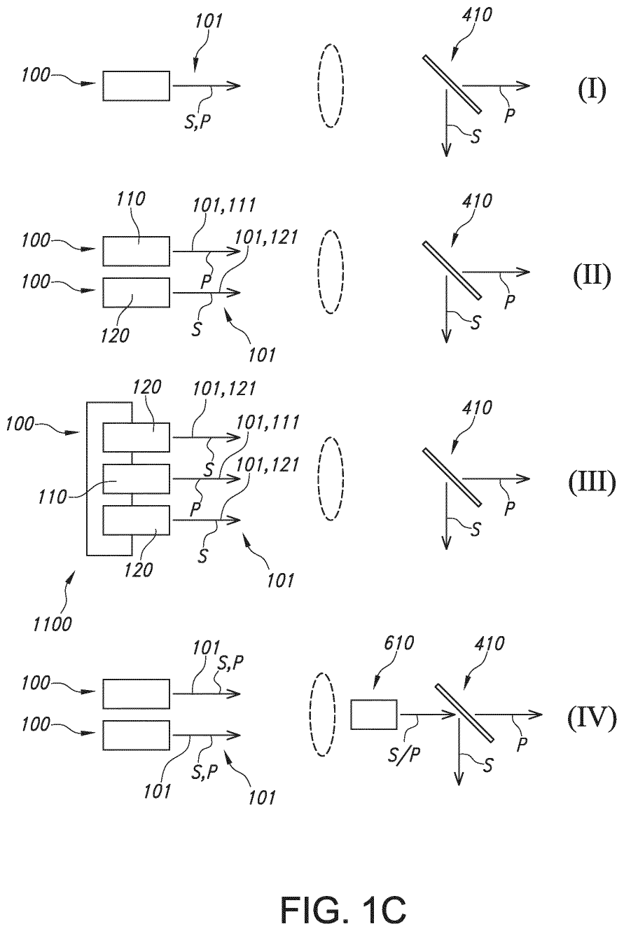

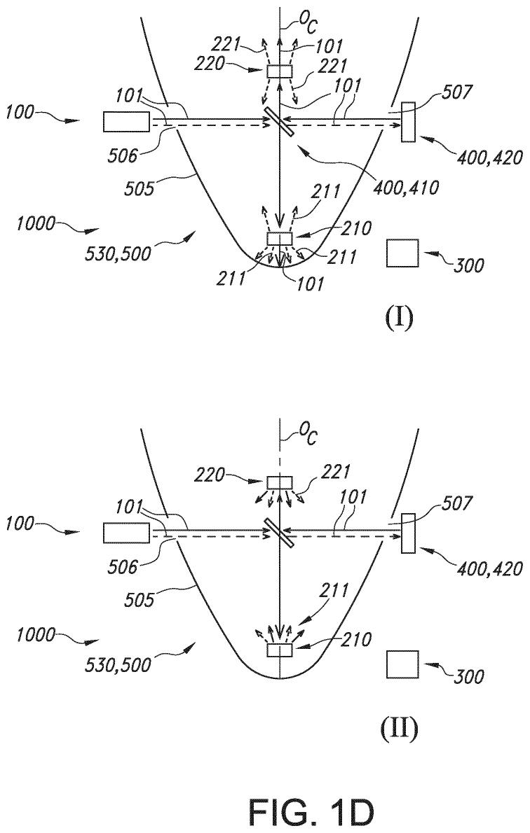

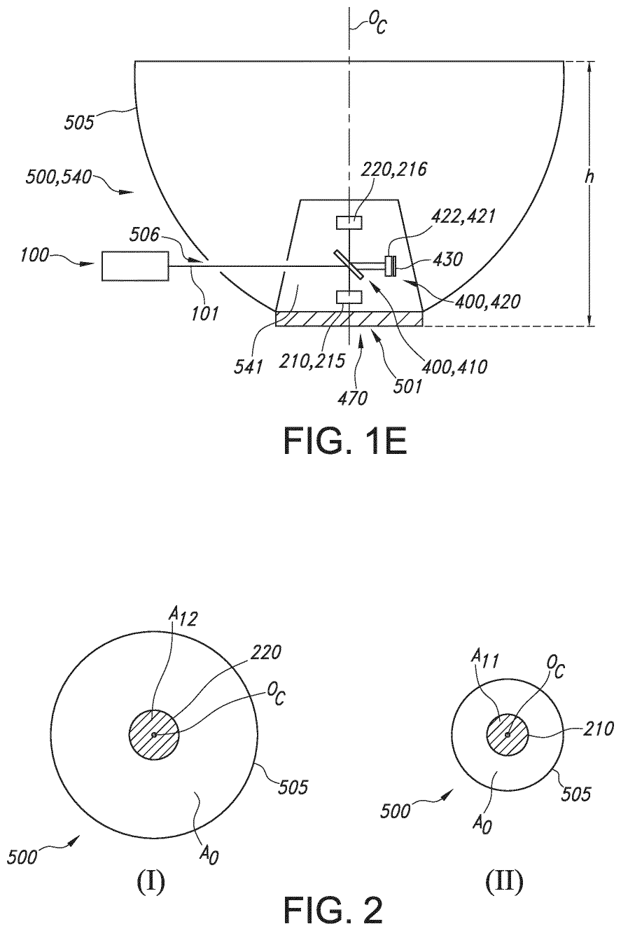

FIGS. 1A-1B schematically depict some embodiments of the invention. In embodiments, the invention may be a light generating system 1000 comprising one or more light generating devices 100, a first luminescent body 210, a second luminescent body 220, an optics arrangement 400, a collimator 500, and a control system 300.

Especially, in embodiments, the one or more light generating devices 100 may be configured to generate device light 101 having a first wavelength λ1 and optionally having a controllable polarization. Further, in embodiments, the one or more light generating devices 100 may comprise one or more solid state light sources, especially laser light sources (such as diode lasers).

Further, in embodiments, the collimator 500 may have a first end 501 and a second end 502. Especially, the collimator 500 may taper from the second end 502 to the first end 501. The first end 501 and the second end 502 may especially be separated by a collimator height h.

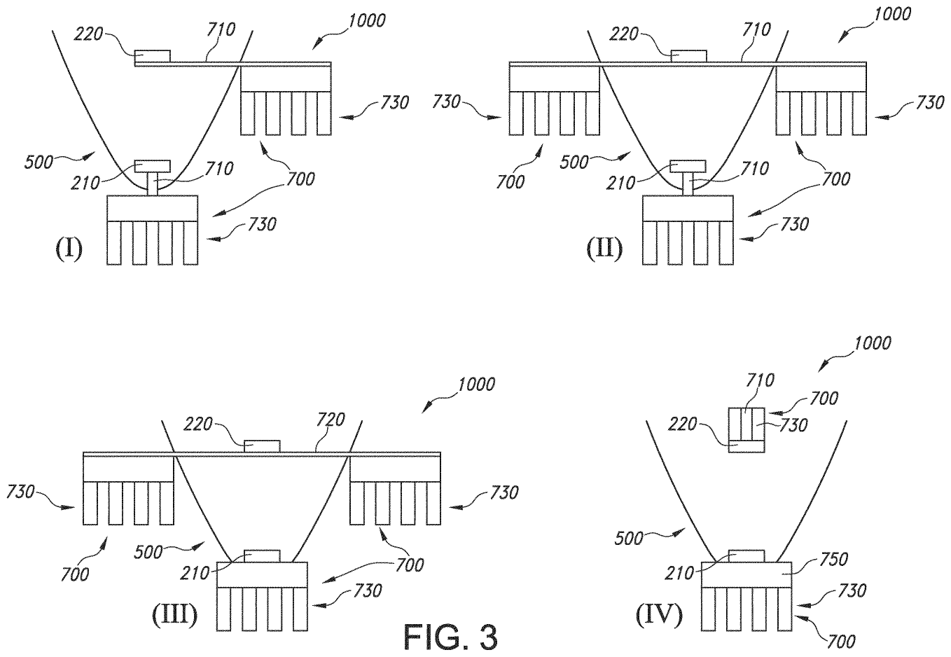

Yet further, the first luminescent body 210 may, in embodiments, be configured to convert at least part of light having the first wavelength λ1 into first luminescent material light 211. Likewise, the second luminescent body 220 may, in embodiments, be configured to convert at least part of light having the first wavelength λ1 into second luminescent material light 221. The first luminescent body 210 and the second luminescent body 220 may, in embodiments, especially be configured in the collimator 500. Especially, the first luminescent body 210 may be configured closer to the first end 501 than the second luminescent body 220, and the second luminescent body 220 may be configured closer to the second end 502 than the first luminescent body 210. Further, in embodiments, the first luminescent body 210 and the second luminescent body 220 may be configured in thermal contact with one or more heat sinks 730 (see FIG. 3)—a heat transfer system (700) configured to transfer heat from one or more of the first luminescent body (210) and the second luminescent body (220)).

Furthermore, in embodiments, the optics arrangement 400 may be configured to direct the device light 101 to the first luminescent body 210 or to the second luminescent body 220, e.g. in dependence of the polarization of the device light 101 (see FIG. 1B) or not necessarily in dependence of polarization (see FIG. 1A).

In FIG. 1A, the optics arrangement 400 may comprise a reflector arrangement 440 comprising one or more reflectors, like including one or more of a double sided reflector, a curved reflector, a prismatic shaped reflector, a reflective polarizer, a dichroic, or a specular reflector. Using light generating devices 100 irradiating the reflector 440 from different sides, may allow addressing the different luminescent bodies 210,220. In this way, the control system 300 can control the beam shape of the system light 1001 by controlling the light generating devices 100.

The light generating system 1000 may be configured to generate system light 1001. The system light 1001 may in embodiments comprise one or more of the first luminescent material light 211 and the second luminescent material light 221.

Especially referring to e.g. FIG. 1B, in embodiments, the control system 300 may be configured to control one or more of a polarization and a radiant flux of the device light 101.

The first luminescent body 210 may, in embodiments, comprise a first luminescent material 215. Likewise, the second luminescent body 220 may, in embodiments, comprise a second luminescent material 216. Especially, the first luminescent material 215 and the second luminescent material 216 may be different.

Further, in embodiments, at least one of the first luminescent material 215 and the second luminescent material 216 may comprise a luminescent material of the type A₃B₅O₁₂:Ce³⁺. In embodiments A may comprise one or more of Y, La, Gd, Tb and Lu, especially (at least) one or more of Y, Gd, Tb and Lu. Furthermore, in embodiments, B may comprise one or more of Al, Ga, In and Sc, especially at least one or more of Al and Ga.

In embodiments, the collimator 500 may comprise a hollow first reflector 530 (see FIGS. 1A, 1B, and 1D). In further embodiments, the collimator may comprise a TIR reflector 540 (see FIG. 1E). In such embodiments, the TIR reflector 540 may comprise a cavity 541. Additionally or alternatively, the cavity 541 may comprise a third reflector 470. Especially, in embodiments, a third reflector 470 may be attached to the first end 501 of the collimator 500. The third reflector 470 may, in embodiments, be essentially comprised by the collimator wall 505.

Further, in embodiments, the one or more light generating devices 100 may comprise one or more lasers. In other embodiments, the one or more light generating devices 100 may comprise one or more superluminescent diodes. In yet other embodiments, the one or more light generating devices 100 may comprise one or more lasers and one or more superluminescent diodes.

FIG. 1C schematically depicts embodiments of the light generating system 1000 comprising a first light generating device 110, configured to generate first device light 111 having a first polarization, and a second light generating device 120, configured to generate second device light 121 having a second polarization. The second polarization may especially be different from the first polarization. Furthermore, in embodiments, the control system 300 may be configured to control the first light generating device 110 and the second light generating device 120.

The light generating system 1000 may further, in embodiments, comprise a laser bank 1100 (see FIG. 1C (III)). The laser bank 1100 may host the first light generating device 110 and the second light generating device 120. Especially, in embodiments, the first light generating device 110 may comprise a first laser and the second light generating device 120 may comprise a second laser.

Additionally or alternatively, the light generating system 1000 may comprise a polarization control system 610 configured to control the polarization of the device light 101 (see FIG. 1C (IV)). Furthermore, the control system 300 may be configured to control the polarization control system 610. In embodiments, the polarization control system 610 may be configured to change a state of polarization of light and/or to control a state of polarization of light. Yet further, in embodiments, the polarization control system 610 may comprise a halfwave plate having a controllable rotation of a fast axis.

FIG. 1B schematically depicts embodiments, wherein the optics arrangement 400 may comprise a polarizing beam splitter 410, configured in the collimator 500, and a retarder arrangement 420. Especially, the polarizing beam splitter 410 may be configured in a light receiving relationship with the one or more light generating devices 100. Further, in embodiments, the polarizing beam splitter 410 may be configured to direct at least part of received device light 101 in the direction of the first luminescent body 210 or the second luminescent body 220 when the device light 101 has a first polarization, and to direct at least part of received device light 101 to the retarder arrangement 420 when the device light 101 has second polarization different from the first polarization. Yet further, in such embodiments, the other one of the first luminescent body 210 and the second luminescent body 220 may be configured in a light receiving relationship with the one or more light generating devices 100 via the retarder arrangement 420 and the polarizing beam splitter 410. Yet further, in such embodiments, the second luminescent body 220 may be configured to receive at least part of device light 101 having the second polarization.

In embodiments, the retarder arrangement 420 may comprise (i) a retarder 421, wherein the retarder 421 may comprise a quarter wave plate 422, and (ii) a second reflector 430. The retarder arrangement 420 may especially be configured external of the collimator 500.

In specific embodiments, the one or more light generating devices 100 may be configured external of the collimator 500. The collimator 500 may especially comprise a collimator wall 505. In embodiments, the collimator wall 505 may taper in a direction from the second end 502 to the first end 501. Further, in embodiments, the collimator wall 505 may comprise a first opening 506 configured between the one or more light generating devices 100 and the polarizing beam splitter 410. The collimator wall 505 may also comprise a second opening 507 configured between the polarizing beam splitter 410 and the retarder arrangement 420.

Further, in embodiments, the first luminescent body 210 and the collimator 500 may be configured such that a first beam 2111 of system light 1001 may have a first beam angle β1 (see FIG. 1B (II)). The first beam 2111 of system light 1001 may especially comprise first luminescent material light 211. Further, the beam angle β1 may be defined by a full width half maximum of at maximum 2°.

Yet further, in embodiments, the second luminescent body 220 and the collimator 500 may be configured such that a second beam 2211 of system light 1001 may have a second beam angle β2 (see FIG. 1B (III)). The second beam 2211 of system light 1001 may especially comprise second luminescent material light 221. Further, the beam angle β2 may be defined by a full width half maximum of at minimum 5°.

The collimator 500 may, in embodiments, have a focal point 550 (see FIG. 1A). Further, in embodiments, the first luminescent body 210 may have a first distance d1 to the focal point 550. Likewise, the second luminescent body 220 may have a second distance d2 to the focal point 550. Especially, d1/d2≤0.1.

In embodiments, the one or more light generating devices 100, the first luminescent body 210 and the second luminescent body 220 may be selected and configured such that spectral properties, selected from color point and correlated color temperature of the system light, 1001 may depend upon the polarization of the device light 101.

In embodiments, the first luminescent body 210 may be configured to absorb part of the device light 101 and to convert it into first luminescent material light 211, and to reflect or transmit (another) part of the device light 101. In other embodiments, the second luminescent body 220 may be configured to absorb part of the device light 101 and to convert it into second luminescent material light 221, and to reflect or transmit (another) part of the device light 101. In such embodiments, the system light 1001 may comprise unconverted device light 101 reflected at or transmitted by the first luminescent body 210 and/or unconverted device light 101 reflected at or transmitted by the second luminescent body 220.

In further embodiments, the first luminescent body 210 may be operated in a transmissive mode and the second luminescent body 220 may be operated in a transmissive mode (see FIG. 1D (I)). In yet further embodiments, the first luminescent body 210 may be operated in a reflective mode and the second luminescent body 220 may be operated in a reflective mode (see FIG. 1D (II)). In yet further embodiments, the first luminescent body 210 may be operated in a reflective mode and the second luminescent body 220 may be operated in a transmissive mode. In yet further embodiments, the first luminescent body 210 may be operated in a transmissive mode and the second luminescent body 220 may be operated in a reflective mode.

For instance referring to FIG. 1D, in specific embodiments the optics arrangement 400 may comprise a reflector arrangement 440, wherein the one or more light generating devices 100 are configured to irradiate the reflector arrangement 440 from different sides of the reflector arrangement 440. The light generating device 100 at the left irradiates, when switched on, the first luminescent body 210. The light generating device 100 at the right irradiates, when switched on, the second luminescent body 220.

Especially, the one or more light generating devices 100 and the reflector arrangement 440 may be configured to irradiate the first luminescent body 210 and the second luminescent body 220. Further, in embodiments, the control system 300 may be configured to control which of the luminescent bodies is irradiated by the device light 101.

FIG. 1E schematically depict an embodiment of a TIR collimator 540. The first luminescent body 210 and the second luminescent body 220, as well as the beam splitter 410 may be configured in a cavity 541. Note that the embodiments schematically depicted in FIG. 1D may also be applied with a TIR collimator 540. A focal point of the TIR collimator 540 may be configured in the cavity 541. Referring to FIG. 1D (as examples) and FIG. 1E, in embodiments the collimator 500 may be hollow or may comprise a cavity 541, respectively. As schematically depicted in FIG. 1E, a third reflector 470 may especially be configured in the (optical) cavity 541. More especially, in embodiments, the third reflector 470 may be attached to the first end 501 of the collimator 500.

In embodiments, a the distance between the first and second luminescent body (210,220) may be at least 0.2 times the height h of the collimator 500 being defined as the distance between the first end 501 and second end 502, preferably at least 0.3, more preferably at least 0.4, more preferably at least 0.5 times the height h. The second luminescent body 220 may be closer arranged to the second end 502 than the first end 501. The first luminescent body 210 may be closer arranged to the first end 501 than the second end 502.

Referring to FIG. 1A, one may use a reflector arrangement 440 which may comprise one or more (specularly reflecting) reflectors. The one or more specularly reflectors may comprise a reflective polarizer.

Referring to FIGS. 1A-1E, elements of the reflector arrangement 440 configured in the collimator 500 may be much smaller that the cross section of the collimator 500 located around the reflector arrangement 440. For instance, the cross-sectional size, perpendicular to an optical axis O_{c} of the collimator 500, may be at maximum 30%, such as at maximum 20%, more especially at maximum 15%, such as at maximum 10%.

Instead of a polarizing beam splitter, a dichroic mirror may be applied when two types of device light (101) can be provided, having different spectral power distributions.

Ref. to FIGS. 1A-1E, in embodiments, the different luminescent bodies may be irradiated by device light 101 having different polarizations. Hence, the optical pathway to the different luminescent bodies may at least depend upon the polarization of the device light 101. In such embodiments, the device light 101 irradiating the first luminescent body 210 and the device light 101 irradiating the second luminescent body 220 may have identical spectral power distributions (though this is not necessarily the case), but may especially have different polarization (such as s-polarization or p-polarization). For instance, a reflective polarizer may be applied. In (other) embodiments, the different luminescent bodies may be irradiated by device light 101 via at least two beams of light propagating via different optical pathways. A reflective face may direct device light 101 from one direction to one of the luminescent bodies and (another) reflective face may direct the device light 101 from another direction to the other one of the luminescent bodies. In such embodiments, the device light 101 irradiating the first luminescent body 210 and the device light 101 irradiating the second luminescent body 220 may have identical spectral power distributions but may also have different spectral power distributions. The polarization may be the same or may be different. For instance, one or more mirrors may be applied. In (yet other) embodiments, the different luminescent bodies may be irradiated by device light 101 having different spectral power distributions. Hence, the optical pathway to the different luminescent bodies at least depends upon the spectral power distribution of the device light 101. In such embodiments, the device light 101 irradiating the first luminescent body 210 and the device light 101 irradiating the second luminescent body 220 will have different spectral power distributions. For instance, a dichroic mirror may be applied.

The system light 1001 may, in embodiments, have controllable correlated color temperatures. Especially, the controllable correlated color temperatures may include correlated color temperatures differing at least 1000 K in dependence of the polarization of the device light 101. More especially, in embodiments, the first beam 2111 of system light 1001 may have a correlated color temperature of at least 7000 K. Additionally or alternatively, in embodiments, the second beam 2211 of system light 1001 may have a correlated color temperature of at maximum 4000 K.

FIG. 2 schematically depicts a top view of embodiments of the light generating system. Especially, the collimator 500 may have a collimator axis O_{c}. Furthermore, the collimator 500 may have a cross-sectional area Aₒ varying over a length of the collimator axis O_{c}. The cross-sectional area Aₒ may be defined perpendicular to the collimator axis O_{c}.

The collimator axis O_{c} may be defined as an imaginary line that defines a path through the collimator along which system light propagates out of the system. Especially, the collimator axis may coincide with the direction of system light with the highest radiant flux.

Additionally or alternatively, the first luminescent body 210 may have a first cross-sectional area A₁₁. The first cross-sectional area A₁₁ may be defined perpendicular to the collimator axis O_{c}. Likewise, the second luminescent body 220 may have a second cross-sectional area A₁₂. The second cross-sectional area A₁₂ may be defined perpendicular to the collimator axis O_{c}. Furthermore, in embodiments, A₁₁/Ao≤0.2 and A₁₂/Ao≤0.2.

FIG. 3 schematically depicts additional embodiments of the light generating system 1000. Especially, the light generating system 1000 may comprise a heat transfer system 700. The heat transfer system 700 may especially be configured to transfer heat from one or more of the first luminescent body 210 and the second luminescent body 220.

Additionally or alternatively, the heat transfer system 700 may comprise one or more of a heat pipe 710 and a light transmissive thermally conductive body 720 (see FIG. 3 (III)) configured in thermal contact with the second luminescent body 220. In specific embodiments, the light transmissive thermally conductive body 720 may be a sapphire substrate. Further, in embodiments, the heat transfer system 700 may especially comprise a plurality of heat pipes 710. In embodiments, the heat pipe 710 may especially be a vapor chamber 750 (see FIG. 3 (IV)). In further embodiments, the heat transfer system 700 may comprise two or more heat sinks 730. In particular embodiments (not shown here), the heat transfer system 700 may also comprise a fan.

Referring to FIG. 3, a first heat sink 730 may be applied, e.g. thermally coupled (i.e. in thermal contact) to the first luminescent body 210 and a second heat sink 730 may be applied, e.g. thermally coupled to the second luminescent body 220, though other arrangements are also possible (see FIG. 3).

An element may be considered in “thermal contact” with another element if it can exchange energy through the process of heat. Hence, the elements may be thermally coupled. In embodiments, thermal contact can be achieved by physical contact. In embodiments, thermal contact may be achieved via a thermally conductive material, such as a thermally conductive glue (or thermally conductive adhesive). Thermal contact may also be achieved between two elements when the two elements are arranged relative to each other at a distance of equal to or less than about 10 μm, though larger distances, such as up to 100 μm may be possible. The shorter the distance, the better the thermal contact. Especially, the distance is 10 μm or less, such as 5 μm or less, such as 1 μm or less. The distance may be the distanced between two respective surfaces of the respective elements. The distance may be an average distance. For instance, the two elements may be in physical contact at one or more, such as a plurality of positions, but at one or more, especially a plurality of other positions, the elements are not in physical contact. For instance, this may be the case when one or both elements have a rough surface. Hence, in embodiments in average the distance between the two elements may be 10 μm or less (though larger average distances may be possible, such as up to 100 μm). In embodiments, the two surfaces of the two elements may be kept at a distance with one or more distance holders. When two elements are in thermal contact, they may be in physical contact or may be configured at a short distance of each other, like at maximum 10 μm, such as at maximum 1 mm. When the two elements are configured at a distance from each other, an intermediate material may be configured in between, though in other embodiments, the distance between the two elements may be filled with a gas, or a liquid, or may be vacuum. When an intermediate material is available, the larger the distance, the higher the thermal conductivity may be useful for thermal contact between the two elements. However, the smaller the distance, the lower the thermal conductivity of the intermediate material may be (of course, higher thermal conductive materials may also be used).

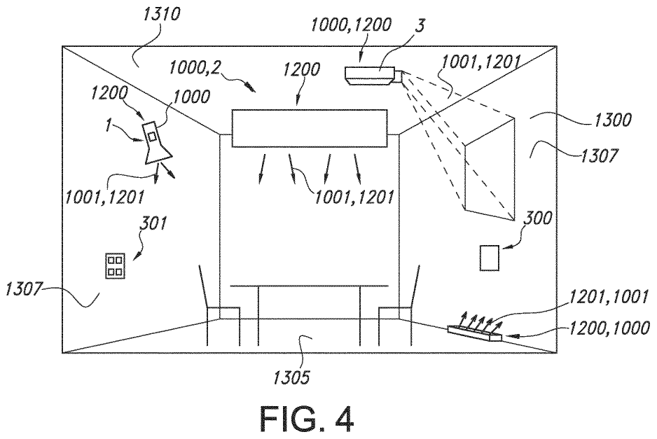

FIG. 4 schematically depicts an embodiment of a luminaire 2 comprising the light generating system 1000 as described above. Reference 301 indicates a user interface which may be functionally coupled with the control system 300 comprised by or functionally coupled to the light generating system 1000. FIG. 4 also schematically depicts an embodiment of lamp 1 comprising the light generating system 1000. Reference 3 indicates a projector device or projector system, which may be used to project images, such as at a wall, which may also comprise the light generating system 1000. Hence, FIG. 4 schematically depicts embodiments of a lighting device 1200 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, or an optical wireless communication device. Lighting device light escaping from the lighting device 1200 is indicated with reference 1201. Lighting device light 1201 may essentially consist of system light 1001, and may in specific embodiments thus be system light 1001. Reference 1300 refers to a space, such as a room, wherein reference 1307 corresponds to the walls of the room, reference 1305 corresponds to the floor, and reference 1310 corresponds to the ceiling. Note that the light generating system 1000 may also be used for stage-lighting.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising one or more light generating devices, a first luminescent body, a second luminescent body, an optics arrangement, a collimator, a control system, and a heat transfer system; wherein:
the one or more light generating devices are configured to generate device light having a first wavelength (λ1); wherein the one or more light generating devices comprise one or more solid state light sources, wherein the one or more solid state light sources comprise laser light sources;
the collimator has a first end and a second end, wherein the collimator tapers from the second end to the first end;
the first luminescent body is configured to convert at least part of light having the first wavelength (λ1) into first luminescent material light;
the second luminescent body is configured to convert at least part of light having the first wavelength (λ1) into second luminescent material light;
the first luminescent body and the second luminescent body are configured in the collimator, wherein the first luminescent body is configured closer to the first end than the second luminescent body;
the heat transfer system is configured to transfer heat from one or more of the first luminescent body and the second luminescent body;
the optics arrangement is configured to direct the device light to the first luminescent body and/or the second luminescent body;
the light generating system is configured to generate system light comprising one or more of the first luminescent material light and the second luminescent material light; wherein the system light has a controllable beam shape; and
the control system is configured to control the system light by controlling the one or more light generating devices.

2. The light generating system according to claim 1; wherein:
the one or more light generating devices are configured to generate device light having a controllable polarization;
the optics arrangement is configured to direct the device light to the first luminescent body and/or the second luminescent body in dependence of the polarization of the device light;
the control system is configured to control the polarization of the device light.

3. The light generating system according to claim 2, wherein the light generating system comprises (i) a first light generating device configured to generate first device light having a first polarization, and (ii) a second light generating device configured to generate second device light having a second polarization, different from the first polarization; wherein the control system is configured to control the first light generating device and the second light generating device.

4. The light generating system according to claim 2, wherein the optics arrangement comprises (i) a polarizing beam splitter, configured in the collimator, and (ii) a retarder arrangement, wherein:
the polarizing beam splitter is configured in a light receiving relationship with the one or more light generating devices;
the polarizing beam splitter is configured to (i) direct at least part of received device light in the direction of the first luminescent body or the second luminescent body when the device light has a first polarization, and (ii) to direct at least part of received device light to the retarder arrangement when the device light has second polarization; wherein the other one of the first luminescent body and the second luminescent body is configured in a light receiving relationship with the one or more light generating devices via the retarder arrangement and the polarizing beam splitter.

5. The light generating system according to claim 4, wherein the retarder arrangement comprises (i) a retarder, wherein the retarder comprises a quarter wave plate, and (ii) a second reflector; wherein the retarder arrangement is configured external of the collimator.

6. The light generating system according to claim 5, wherein:
the one or more light generating devices are configured external of the collimator; wherein the collimator comprises a collimator wall, wherein the collimator wall tapers in a direction from the second end to the first end;
the collimator wall comprises a first opening configured between the one or more light generating devices and the polarizing beam splitter; and
the collimator wall comprises a second opening configured between the polarizing beam splitter and the retarder arrangement.

7. The light generating system according to claim 2, wherein the one or more light generating devices, the first luminescent body and the second luminescent body are selected and configured such that spectral properties selected from color point and correlated color temperature of the system light depend upon the polarization of the device light.

8. The light generating system according to claim 1, wherein the optics arrangement comprises a reflector arrangement, wherein the one or more light generating devices are configured to irradiate the reflector arrangement from different sides of the reflector arrangement, wherein the one or more light generating devices and the reflector arrangement are configured to irradiate the first luminescent body and the second luminescent body, wherein the control system is configured to control which of the luminescent bodies is irradiated by the device light.

9. The light generating system according to claim 1, wherein the first luminescent body and the collimator are configured such that a first beam of system light comprising first luminescent material light has a first beam angle (β1) defined by a full width half maximum of at maximum 2°; and wherein the second luminescent body and the collimator are configured such that a second beam of system light comprising second luminescent material light has a second beam angle (β2) defined by a full width half maximum of at minimum 5°.

10. The light generating system according to claim 1, wherein the collimator comprises a hollow first reflector or a total internal reflection collimator.

11. The light generating system according to claim 1, wherein the first luminescent body comprises a first luminescent material, wherein the second luminescent body comprises a second luminescent material, wherein the first luminescent material and the second luminescent material are different; wherein at least one of the first luminescent material and the second luminescent material comprises a luminescent material of the type A₃B₅O₁₂:Ce, wherein A in embodiments comprises one or more of Y, La, Gd, Tb and Lu, and wherein B in embodiments comprises one or more of Al, Ga, In and Sc.

12. The light generating system according to claim 1, comprising a laser bank, wherein the laser bank hosts the first light generating device and the second light generating device, wherein the first light generating device comprises a first laser and wherein the second light generating device comprises a second laser.

13. The light generating system according to claim 1, wherein the system light has a controllable correlated color temperatures including correlated color temperatures differing at least 1000 K in dependence of the polarization of the device light, wherein the first beam of system light has a correlated color temperature of at least 7000 K, and wherein the second beam of system light has a correlated color temperature of at maximum 4000 K.

14. The light generating system according to claim 1, wherein the heat transfer system comprises one or more heat sinks, wherein the first luminescent body and the second luminescent body are configured in thermal contact with the one or more heat sinks.

15. A lighting device selected from the group of a lamp (1), a luminaire (2), and a projector device (3), comprising the light generating system according to claim 1.
